(19) United States
(12) Patent Application Publication
(10) Pub. No.: US 2020/0274413 A1
(43) Pub. Date: Aug. 27, 2020

(54) STATOR, STATOR ASSEMBLY, AND METHOD OF MANUFACTURING STATOR

(71) Applicant: Mitsubishi Electric Corporation, Chiyoda-ku, Tokyo (JP)

(72) Inventors: Kohei EGASHIRA, Tokyo (JP); Tatsuro HINO, Tokyo (JP); Masashi NAKAMURA, Tokyo (JP); Shohei MATSUOKA, Tokyo (JP)

(73) Assignee: Mitsubishi Electric Corporation, Chiyoda-ku, Tokyo (JP)

(21) Appl. No.: 16/647,662

(22) PCT Filed: Oct. 19, 2018
(86) PCT No.: PCT/JP2018/039093

§ 371 Date: Mar. 16, 2020

(30) Foreign Application Priority Data
Oct. 26, 2017 (JP) 2017-206923

(51) Int. Cl. H02K 3/12; H02K 3/34; H02K 15/04

(52) U.S. Cl. CPC H02K 3/12; H02K 15/04; H02K 3/34

(57) ABSTRACT

In a stator of the present invention, oblique-side portions of a pair of terminal wires to be welded to each other extend so as to approach each other and are located at different positions in a radial direction of a stator core, and straight portions of the pair of the terminal wires to be welded to each other are parallel to each other when viewed in the radial direction, and one of the straight portions is inclined in a direction toward another one of the straight portions through a boundary portion between the one straight portion and the oblique-side portion corresponding to the one straight portion as a bent portion in the radial direction so that a distal end portion of the one straight portion and a distal end portion of the another one of the straight portions overlap with each other when viewed in the circumferential direction.

### TECHNICAL FIELD

The present invention relates to a stator for a rotating electric machine such as an electric motor or a power generator, a stator assembly, and a method of manufacturing the stator, and more particularly, to a wire connection structure of a stator winding.

### BACKGROUND ART

In a related-art stator winding for a rotating electric machine, a plurality of segment coils, each having a U-shape formed of a pair of straight portions and a coupling portion, are mounted to slots of a stator core. Of distal end portions of the pair of straight portions projecting toward a side opposite to the coupling portion, a distal end portion which is located at an odd-numbered position from an outer periphery side or an inner periphery side in a radial direction is bent in one direction, and a distal end portion which is located at an even-numbered position is bent in a direction opposite to the one direction. The distal end portion bent in the one direction and the distal end portion bent in the opposite direction are welded to each other (see, for example, Patent Literature 1).

### CITATION LIST

### Patent Literature

[PTL 1] JP 5637301 B2

### SUMMARY OF INVENTION

### Technical Problem

In the related-art stator winding, the distal end side of each of the straight portions is bent into a crank shape. Thus, the distal end portions welded to each other are shifted in the radial direction of the stator core by a half of a thickness of a conductor wire in the radial direction of the stator core with respect to portions of the straight portions inserted in the slots and extend in parallel to an axial direction of the stator core. As a result, the distal end portions are welded to each other in a state of being held in contact with each other in a circumferential direction of the stator core. In this manner, in the related-art stator winding, the distal end side of each of the straight portions is bent twice at a right angle as a bending angle. Therefore, there arises a problem in that an insulating coating covering the straight portion is damaged at a bent portion, resulting in a lower insulating property. Further, when a curvature radius of the bent portion is increased so as to suppress occurrence of damage to the insulating coating at the bent portion, there arises a problem in that a distance of a weld portion between the distal end portions from an end surface of the stator core is increased, causing increase in axial dimension of the stator.

The present invention has been made to solve the problems described above, and has an object to provide a stator, a stator assembly, and a method of manufacturing the stator, with which increase in axial dimension of the stator can be suppressed while an insulating property of a stator winding is ensured.

### Solution to Problem

According to one embodiment of the present invention, there is provided a stator, including: a stator core having an annular shape, which has slots arranged at constant pitches in a circumferential direction of the stator core; and a stator winding, which is mounted to the stator core, and includes a plurality of unit coils each being formed of a conductor wire covered with an insulation coating. Each of the plurality of unit coils includes 2n slot insertion portions to be inserted into the slots, (2n−1) turn portions configured to continuously couple the 2n slot insertion portions outside the slots, and two terminal wires projecting from the slot insertion portions of the 2n slot insertion portions, which are located at both ends, to an outside of the slots, where n is an integer equal to or larger than 1, wherein each of the two terminal wires has an oblique-side portion, which extends in the circumferential direction of the stator core, and gradually separates away from the stator core in a direction toward a distal end while maintaining a position in a radial direction of the stator core, and a straight portion extending outward from the distal end of the oblique-side portion in an axial direction of the stator core. The plurality of unit coils are electrically connected by welding a distal end portion of the straight portion of the terminal wire of one of the unit coils and a distal end portion of the straight portion of the terminal wire of another one of the unit coils being a subject of connection, the oblique-side portions of a pair of the terminal wires to be welded to each other extend so as to approach each other and are located at different positions in the radial direction of the stator core, and the straight portions of the pair of the terminal wires to be welded to each other are parallel to each other when viewed in the radial direction, and one of the straight portions is inclined in a direction toward another one of the straight portions through a boundary portion between the one straight portion and the oblique-side portion corresponding to the one straight portion as a bent portion in the radial direction so that the distal end portion of the one straight portion and the distal end portion of the another one of the straight portions overlap with each other when viewed in the circumferential direction of the stator core.

### Advantageous Effects of Invention

According to one embodiment of the present invention, the distal end portions of the straight portions can be chucked in the circumferential direction of the stator core. Thus, each of the straight portions is bent once in the radial direction, and hence a bending angle of each of the straight portions in the radial direction is reduced. As a result, the stator, a stator assembly, and a method of manufacturing the stator, with which increase in axial dimension of the stator can be suppressed while an insulating property of the stator winding is ensured.

### BRIEF DESCRIPTION OF DRAWINGS

FIG. 1 is a half sectional view for illustrating a rotating electric machine according to a first embodiment of the present invention.

FIG. 2 is a perspective view for illustrating a main part of the rotating electric machine according to the first embodiment of the present invention.

FIG. 3 is a perspective view for illustrating a stator in the rotating electric machine according to the first embodiment of the present invention.

FIG. 4 is a perspective view for illustrating a core block for forming a stator core in the rotating electric machine according to the first embodiment of the present invention.

FIG. 5 is an end view for illustrating a first winding body for forming a stator winding in the rotating electric machine according to the first embodiment of the present invention when viewed from an axially outer side.

FIG. 6 is a front view for illustrating the first winding body for forming the stator winding in the rotating electric machine according to the first embodiment of the present invention when viewed from a radially inner side.

FIG. 7 is an end view for illustrating a second winding body for forming the stator winding in the rotating electric machine according to the first embodiment of the present invention when viewed from the axially outer side.

FIG. 8 is a front view for illustrating the second winding body for forming the stator winding in the rotating electric machine according to the first embodiment of the present invention when viewed from the radially inner side.

FIG. 9 is a sectional view of a main part, for schematically illustrating a slot accommodation state of a winding body in the rotating electric machine according to the first embodiment of the present invention.

FIG. 10 is an end view for illustrating a stator assembly in the rotating electric machine according to the first embodiment of the present invention when viewed from the axially outer side.

FIG. 11 is a sectional view taken along the line A-A of FIG. 10 when viewed in the direction indicated by the arrows.

FIG. 12 is a perspective view for illustrating a stator winding assembly in the rotating electric machine according to the first embodiment of the present invention.

FIG. 13 is a perspective view for illustrating one phase winding for forming the stator winding assembly in the rotating electric machine according to the first embodiment of the present invention.

FIG. 14 is an end view for illustrating a joint portion of the winding bodies in the stator for a rotating electric machine according to the first embodiment of the present invention when viewed from the axially outer side.

FIG. 15 is a plan view for illustrating the joint portion of the winding bodies in the stator for a rotating electric machine according to the first embodiment of the present invention when viewed from the radially inner side.

FIG. 16 is a plan view for illustrating the joint portion of the winding bodies in the stator for a rotating electric machine according to the first embodiment of the present invention when viewed in a circumferential direction of the stator core.

FIG. 17 is a schematic view for illustrating a first coil end in the stator for a rotating electric machine according to the first embodiment of the present invention.

FIG. 18 is a side view of a main part, for illustrating a straight portion of a first turn portion of the winding body and a periphery thereof according to one aspect of the stator for a rotating electric machine according to the first embodiment of the present invention.

FIG. 19 is a flowchart for illustrating a method of manufacturing the stator for a rotating electric machine according to the first embodiment of the present invention.

FIG. 20 is a plan view for illustrating the first turn portion in the stator for a rotating electric machine according to the first embodiment of the present invention when viewed from the radially inner side.

FIG. 21 is a plan view for illustrating the first turn portion in the stator for a rotating electric machine according to the first embodiment of the present invention when viewed in the circumferential direction.

FIG. 22 is an explanatory view for illustrating a terminal wire distal end portion forming step in the stator for a rotating electric machine according to the first embodiment of the present invention.

FIG. 23 is an explanatory view for illustrating the terminal wire distal end portion forming step in the stator for a rotating electric machine according to the first embodiment of the present invention.

FIG. 24 is an explanatory view for illustrating the terminal wire distal end portion forming step in the stator for a rotating electric machine according to the first embodiment of the present invention.

FIG. 25 is an explanatory view for illustrating the terminal wire distal end portion forming step in the stator for a rotating electric machine according to the first embodiment of the present invention.

FIG. 26 is an explanatory view for illustrating the terminal wire distal end portion forming step in the stator for a rotating electric machine according to the first embodiment of the present invention.

FIG. 27 is an explanatory view for illustrating the terminal wire distal end portion forming step in the stator for a rotating electric machine according to the first embodiment of the present invention.

FIG. 28 is an explanatory view for illustrating a terminal joining step in the stator for a rotating electric machine according to the first embodiment of the present invention.

FIG. 29 is an explanatory view for illustrating the terminal joining step in the stator for a rotating electric machine according to the first embodiment of the present invention.

FIG. 30 is an explanatory view for illustrating the terminal joining step in the stator for a rotating electric machine according to the first embodiment of the present invention.

FIG. 31 is a plan view for illustrating a state in which straight portions in a stator of a comparative example are held with chucks when viewed in a circumferential direction of the stator core.

FIG. 32 is an end view for illustrating a terminal wire connection portion of winding bodies according to one aspect of a stator for a rotating electric machine according to a second embodiment of the present invention when viewed from an axially outer side.

FIG. 33 is a plan view for illustrating the terminal wire connection portion of the winding bodies according to the one aspect of the stator for a rotating electric machine according to the second embodiment of the present invention when viewed in the circumferential direction.

FIG. 34 is a plan view for illustrating a terminal wire connection portion of winding bodies according to one aspect of a stator for a rotating electric machine according to a third embodiment of the present invention when viewed in a circumferential direction of the stator core.

FIG. 35 is a plan view for illustrating a terminal wire connection portion of winding bodies in a stator for a rotating electric machine according to a fourth embodiment of the present invention when viewed in a circumferential direction of the stator core.

FIG. 36 is a plan view for illustrating the terminal wire connection portion of the winding bodies according to one aspect of the stator for a rotating electric machine according to the fourth embodiment of the present invention when viewed in the circumferential direction.

FIG. 37 is a schematic view for illustrating a first coil end in a stator for a rotating electric machine according to a fifth embodiment of the present invention.

FIG. 38 is a schematic view for illustrating a terminal wire connection portion in a stator for a rotating electric machine according to a sixth embodiment of the present invention when viewed in a circumferential direction of the stator.

FIG. 39 is an explanatory view for illustrating a terminal wire distal end portion forming step in a stator for a rotating electric machine according to a seventh embodiment of the present invention.

FIG. 40 is an explanatory view for illustrating the terminal wire distal end portion forming step in the stator for a rotating electric machine according to the seventh embodiment of the present invention.

FIG. 41 is an explanatory view for illustrating the terminal wire distal end portion forming step in the stator for a rotating electric machine according to the seventh embodiment of the present invention.

FIG. 42 is an explanatory view for illustrating the terminal wire distal end portion forming step in the stator for a rotating electric machine according to the seventh embodiment of the present invention.

FIG. 43 is a plan view for illustrating a bending tool for the stator for a rotating electric machine according to the seventh embodiment of the present invention.

FIG. 44 is a sectional view taken along the line A-A of FIG. 43 when viewed in the direction indicated by the arrows.

### DESCRIPTION OF EMBODIMENTS

Now, with reference to the drawings, a rotating electric machine according to exemplary embodiments of the present invention is described.

### First Embodiment

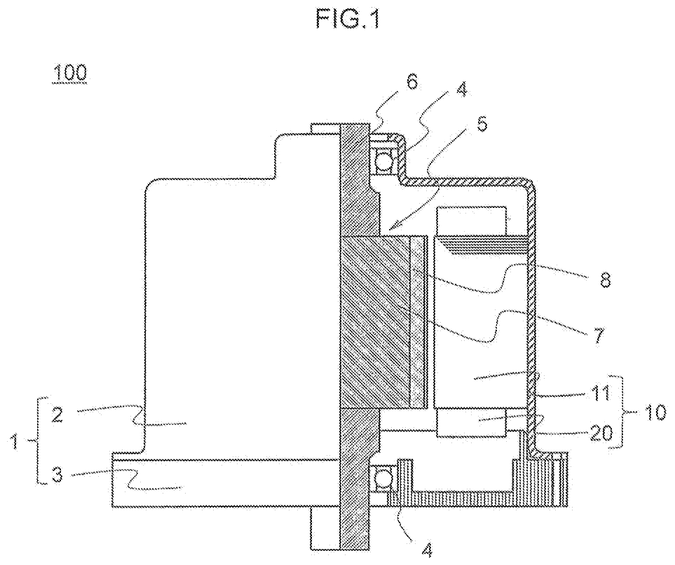

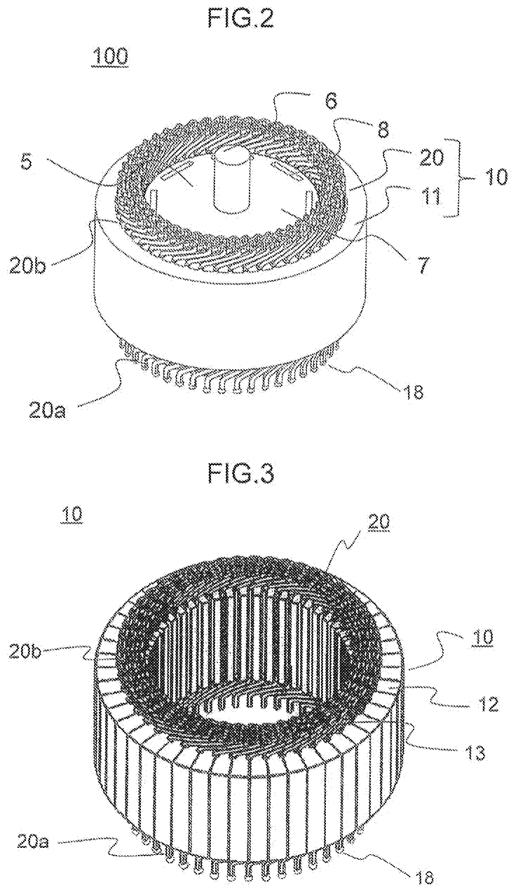

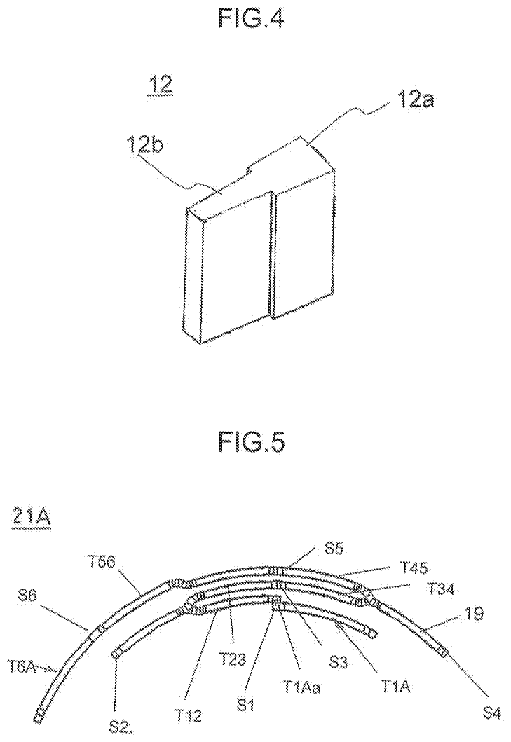

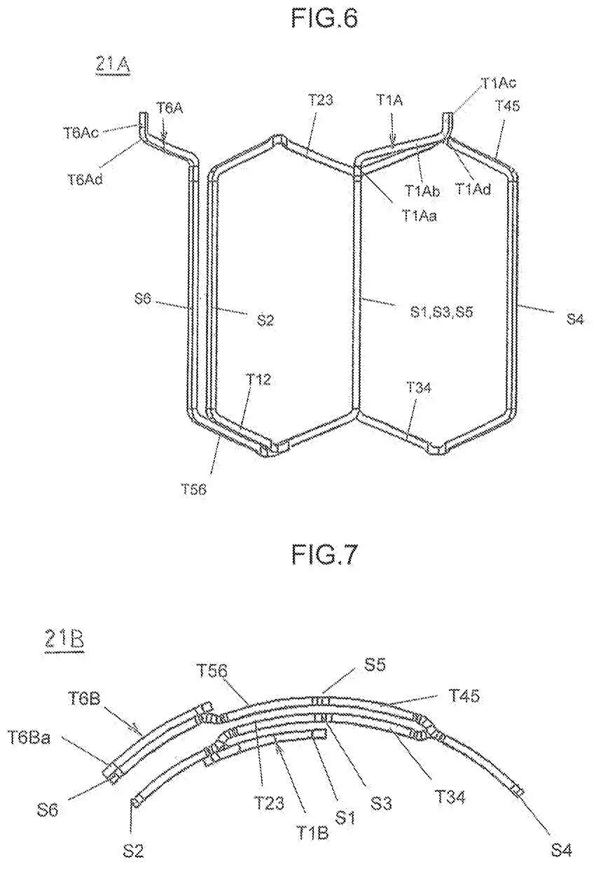

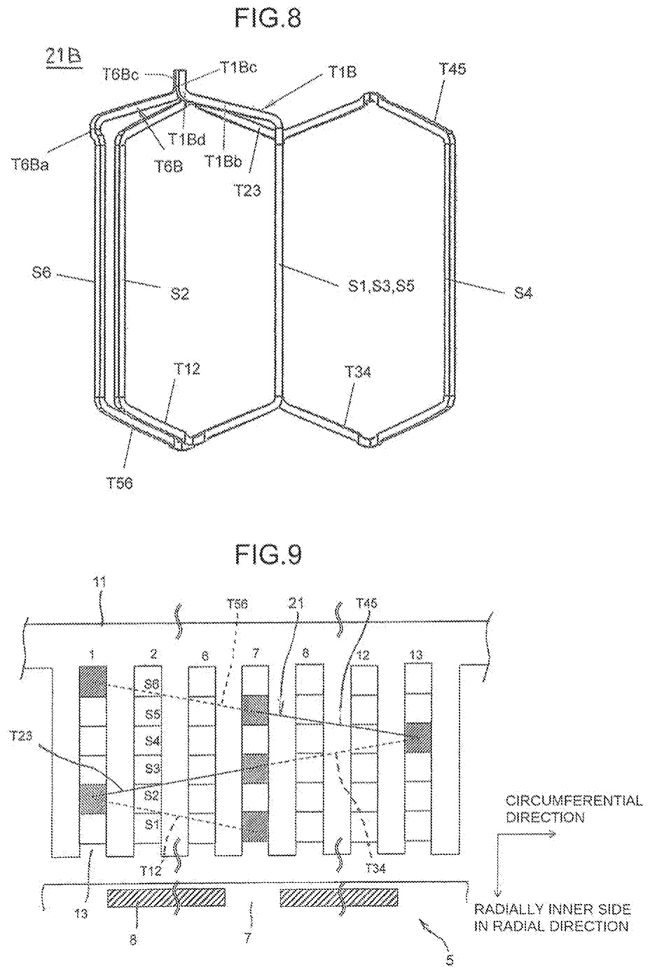

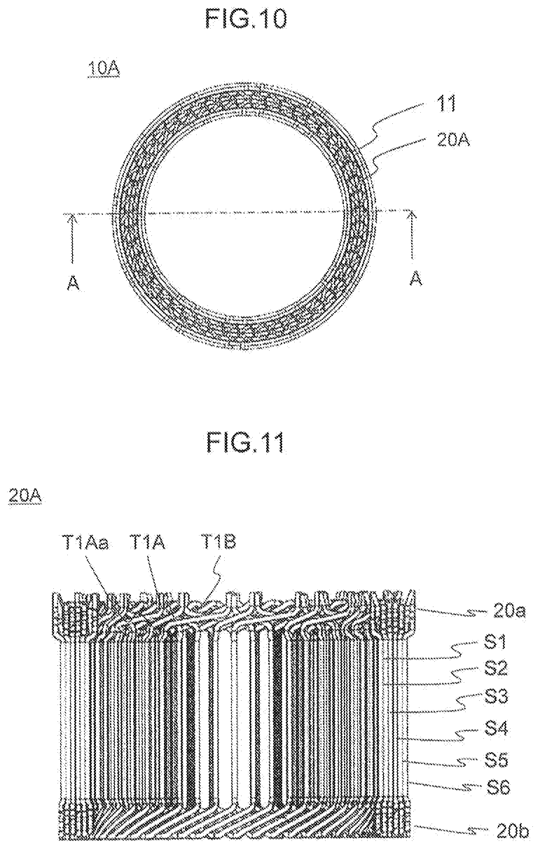

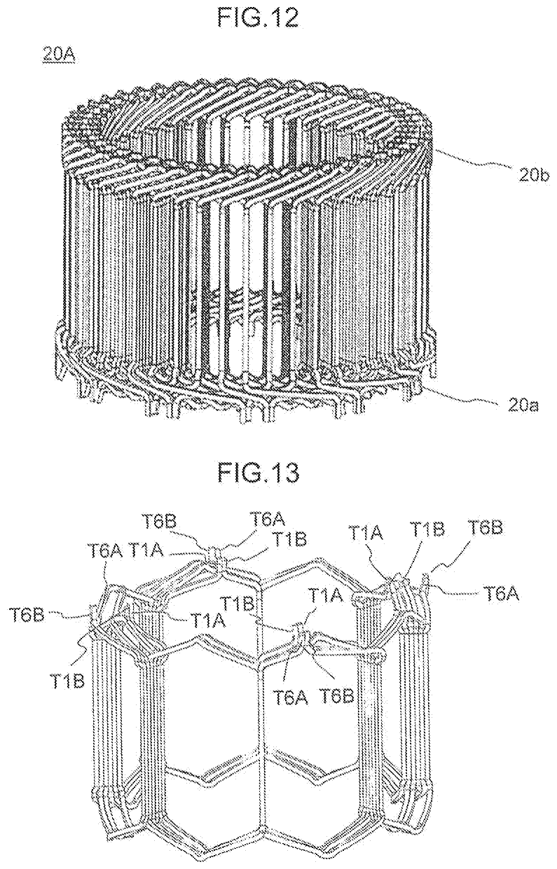

FIG. 1 is a half sectional view for illustrating a rotating electric machine according to a first embodiment of the present invention. FIG. 2 is a perspective view for illustrating a main part of the rotating electric machine according to the first embodiment of the present invention. FIG. 3 is a perspective view for illustrating a stator in the rotating electric machine according to the first embodiment of the present invention. FIG. 4 is a perspective view for illustrating a core block for forming a stator core in the rotating electric machine according to the first embodiment of the present invention. FIG. 5 is an end view for illustrating a first winding body for forming a stator winding in the rotating electric machine according to the first embodiment of the present invention when viewed from an axially outer side. FIG. 6 is a front view for illustrating the first winding body for forming the stator winding in the rotating electric machine according to the first embodiment of the present invention when view from a radially inner side. FIG. 7 is an end view for illustrating a second winding body for forming the stator winding in the rotating electric machine according to the first embodiment of the present invention when viewed from the axially outer side. FIG. 8 is a front view for illustrating the second winding body for forming the stator winding in the rotating electric machine according to the first embodiment of the present invention when viewed from the radially inner side. FIG. 9 is a sectional view of a main part, for schematically illustrating a slot accommodation state of a winding body in the rotating electric machine according to the first embodiment of the present invention. FIG. 10 is an end view for illustrating a stator assembly in the rotating electric machine according to the first embodiment of the present invention when viewed from the axially outer side. FIG. 11 is a sectional view taken along the line A-A of FIG. 10 when viewed in the direction indicated by the arrows. FIG. 12 is a perspective view for illustrating a stator winding assembly in the rotating electric machine according to the first embodiment of the present invention. FIG. 13 is a perspective view for illustrating one phase winding for forming the stator winding assembly in the rotating electric machine according to the first embodiment of the present invention. In FIG. 9, only slot insertion portions are illustrated as the winding body, and slot numbers 1, 2, . . . , 12, and 13 are slot numbers allocated to slots in the order of arrangement in a circumferential direction of the stator core.

In FIG. 1 and FIG. 2, a rotating electric machine 100 includes a frame 2, an end plate 3, a stator 10, and a rotor 5. The frame 2 has a bottomed cylindrical shape having a cylindrical portion and a bottom portion configured to close an opening on one side of the cylindrical portion. The end plate 3 is configured to close an opening on another side of the cylindrical portion of the frame 2. The stator 10 is inserted into the cylindrical portion of the frame 2 and retained therein. The rotor 5 is firmly fixed to a rotary shaft 6 rotatably supported in the bottom portion of the frame 2 and the end plate 3 through intermediation of bearings 4, and is rotatably arranged on an inner periphery side of the stator 10. In this case, the frame 2 and the end plate 3 form a housing 1.

The rotor 5 is a permanent magnet rotor including a rotor core 7 and permanent magnets 8. The rotor core 7 is firmly fixed to the rotary shaft 6 inserted therethrough at an axial center position. The permanent magnets 8 are embedded in the rotor core 7 on an outer peripheral surface side of the rotor core 7 and are arranged at equal pitches in a circumferential direction of the rotor 5 to form magnetic poles. The rotor 5 is not limited to the permanent magnet rotor, and may be a squirrel-cage rotor in which an uninsulated rotor conductor is accommodated in slots of the rotor core and both sides thereof are short-circuited with use of a short-circuit ring or a winding rotor in which an insulated conductor wire is mounted to the slots of the rotor core.

Next, a configuration of the stator 10 is specifically described with reference to FIG. 3 to FIG. 12. For convenience of description, an axial direction of the rotary shaft 6 is referred to as “axial direction”, a radial direction of the rotary shaft 6 is referred to as “radial direction”, and a rotating direction about an axis of the rotary shaft 6 is referred to as “circumferential direction”.

The stator 10 includes, as illustrated in FIG. 3, a stator core 11 and a stator winding 20 mounted to the stator core 11. Although not shown, ground insulating members configured to isolate the stator winding 20 and the stator core 11 from each other are mounted to slots 13 of the stator core 11. Further, although not shown, phase-to-phase insulating members configured to isolate phases of the stator winding 20 from each other are mounted to coil ends of the stator winding 20.

For convenience of the description, a pole number of the rotor 5 is set to 8, a slot number of the stator core 11 is set to 48, and the stator winding 20 is set to a three-phase winding. Specifically, the slots 13 are formed in the stator core 11 in a proportion of two slots per phase for each pole.

The stator core 11 includes forty-eight core blocks 12. Each of the core blocks 12 has, as illustrated in FIG. 4, a core back portion 12a having an arc-shaped cross section and a tooth 12b projecting radially inward from an inner peripheral wall surface of the core back portion 12a. The core block 12 is formed by, for example, laminating T-shaped core pieces each punched from an electromagnetic steel sheet. The forty-eight core blocks 12 are inserted into and retained in the cylindrical portion of the frame 2 through, for example, press-fitting or shrink-fitting under a state in which circumferential side surfaces of the core back portions 12a abut against each other so that the core back portions 12 are arranged in an annular shape. The forty-eight core blocks 12 are arranged in an annular shape to form the stator core 11. The stator core 11 includes a core back having an annular shape and forty-eight teeth 12b. The core back includes forty-eight core back portions 12a. The forty-eight teeth 12b, each extending radially inward from an inner peripheral surface of the core back, are arranged at equal pitches in a circumferential direction of the stator core 11. A space defined between adjacent teeth 12b serves as the slot 13.

The stator winding 20 includes a plurality of winding bodies 21, each serving as a unit coil, and are formed by connecting terminal wires of winding bodies 21 being subjects of connection through a weld portion 18. The winding bodies 21 include first winding bodies 21A and second winding bodies 21B, which have different directions in which the terminal wire extends. In this case, the first winding body 21A and the second winding body 21B are basically the same, and are distinguished from each other with additional symbols A and B. When the winding bodies are collectively referred, the reference symbol without the additional symbol A or B is used. For convenience of the description, a coil pattern of the winding body is described based on a state in which the winding body is inserted in the slot.

The first winding body 21A has the following coil pattern. A conductor wire 19 having a rectangular cross section is formed of, for example, a copper wire or an aluminum wire, which is insulation-coated and is continuous without a connection portion. The conductor wire 19 is inserted into a first slot, a second slot, and a third slot, which are arranged in the circumferential direction so as to be separate from each other by a six-slot distance. The conductor wire 19 is inserted into the second slot, the first slot, the second slot, the third slot, the second slot, and the first slot in the stated order while alternately changing an axial insertion direction into the first slot, the second slot, and the third slot so that a radial insertion position inside the slot 13 is sequentially shifted radially outward by one layer. Specifically, the first winding body 21A has a coil pattern resembling a shape of “8” turned sideways when viewed from a radially inner side. The thus manufactured first winding body 21A is a winding formed by distributed winding and lap winding. A conductor wire having a circular cross section may be used in place of the conductor wire 19 having the rectangular cross section. The six-slot distance is a distance between the slots 13 located on both sides of six teeth 12b, which are continuous in the circumferential direction, and corresponds to one magnetic-pole pitch. Further, the insulation coating of the conductor wire 19 is formed by, for example, coating a bare wire with an enamel resin at a thickness of 50 μm.

The first winding body 21A includes, as illustrated in FIG. 5 and FIG. 6, a first slot insertion portion S1, a second slot insertion portion S2, a third slot insertion portion S3, a fourth slot insertion portion S4, a fifth slot insertion portion S5, a sixth slot insertion portion S6, a first turn portion T1A, a second turn portion T12, a third turn portion T23, a fourth turn portion T34, a fifth turn portion T45, a sixth turn portion T56, and a seventh turn portion T6A. The first slot insertion portion S1, the second slot insertion portion S2, the third slot insertion portion S3, the fourth slot insertion portion S4, the fifth slot insertion portion S5, and the sixth slot insertion portion S6 are arranged in three rows so that the rows are separate from each other by the six-slot distance. The first turn portion T1A extends from one end of the first slot insertion portion S1. The second turn portion T12 couples another end of the first slot insertion portion S1 and another end of the second slot insertion portion S2 to each other. The third turn portion T23 couples one end of the second slot insertion portion S2 and one end of the third slot insertion portion S3 to each other. The fourth turn portion T34 couples another end of the third slot insertion portion S3 and another end of the fourth slot insertion portion S4 to each other. The fifth turn portion T45 couples one end of the fourth slot insertion portion S4 and one end of the fifth slot insertion portion S5 to each other. The sixth turn portion T56 couples another end of the fifth slot insertion portion S5 and another end of the sixth slot insertion portion S6 to each other. The seventh turn portion T6A extends from one end of the sixth slot insertion portion S1. In this case, the first turn portion T1A corresponds to a terminal wire on the radially inner side, and the seventh turn portion T6A corresponds to a terminal wire on the radially outer side terminal.

The second slot insertion portion S2 is shifted radially outward with respect to the first slot insertion portion S1 by a radial thickness of the conductor wire 19 through a crank portion formed at a circumferential intermediate position in the second turn portion T12. The third slot insertion portion S3 is shifted radially outward with respect to the second slot insertion portion S2 by a radial thickness of the conductor wire 19 through a crank portion formed at a circumferential intermediate position in the third turn portion T23. The fourth slot insertion portion S4 is shifted radially outward with respect to the third slot insertion portion S3 by a radial thickness of the conductor wire 19 through a crank portion formed at a circumferential intermediate position in the fourth turn portion T34. The fifth slot insertion portion S5 is shifted radially outward with respect to the fourth slot insertion portion S4 by a radial thickness of the conductor wire 19 through a crank portion formed at a circumferential intermediate position in the fifth turn portion T45. The sixth slot insertion portion S6 is shifted radially outward with respect to the fifth slot insertion portion S5 by a radial thickness of the conductor wire 19 through a crank portion formed at a circumferential intermediate position in the sixth turn portion T56.

The second turn portion T12 has a crank portion and a pair of oblique-side portions. The crank portion corresponds to an apex. The pair of oblique-side portions connect a radially inner side end portion of the crank portion and another end of the first slot insertion portion S1 to each other and connect a radially outer side end portion of the crank portion and another end of the second slot insertion portion S2 to each other. When the winding body 21 is mounted to the stator core 11, one of the oblique-side portions extends from the another end of the first slot insertion portion S1 toward the radially inner side end portion of the crank portion so as to gradually separate away from the stator core 11 while maintaining a radial position so as to be connected to the radially inner side end portion of the crank portion. Further, another one of the oblique-side portions extends from the another end of the second slot insertion portion S2 toward the radially outer side end portion of the crank portion so as to gradually separate away from the stator core 11 while maintaining a radial position so as to be connected to the radially outer side end portion of the crank portion. The third turn portion T23, the fourth turn portion T34, . . . , and the sixth turn portion T56 have the same configuration as the second turn portion T12.

The first turn portion T1A is shifted radially inward by the radial thickness of the conductor wire 19 at a crank portion T1Aa after extending from the one end of the first slot insertion portion S1, then extends in parallel to an oblique-side portion of the fifth turn portion T45, which is connected to the one end of the fifth slot insertion portion S5, while maintaining a radial position, and then is bent to extend axially outward.

The seventh turn portion T6A extends from one end of the sixth slot insertion portion S6 in parallel to an oblique-side portion of the third turn portion T23, which is connected to the one end of the third slot insertion portion S3, while maintaining a radial position, and then is bent to extend axially outward.

The second winding body 21B, as illustrated in FIG. 7 and FIG. 8, has the following coil pattern which is similar to the coil pattern of the first winding body 21A. The conductor wire 19 is inserted into a first slot, a second slot, and a third slot, which are arranged in the circumferential direction so as to be separate from each other by a six-slot distance. The conductor wire 19 is inserted into the second slot, the first slot, the second slot, the third slot, the second slot, and the first slot in the stated order while alternately changing an axial insertion direction into the first slot, the second slot, and the third slot so that a radial insertion position inside the slot 13 is sequentially shifted radially outward by one layer. Specifically, the second winding body 21B has a coil pattern resembling a shape of “8” turned sideways when viewed from a radially inner side.

More specifically, the second winding body 21B includes the first slot insertion portion S1, the second slot insertion portion S2, the third slot insertion portion S3, the fourth slot insertion portion S4, the fifth slot insertion portion S5, the sixth slot insertion portion S6, a first turn portion T1B, the second turn portion T12, the third turn portion T23, the fourth turn portion T34, the fifth turn portion T45, the sixth turn portion T56, and a seventh turn portion T6B. The first turn portion T1B corresponds to a terminal wire on the radially inner side, and the seventh turn portion T6B corresponds to a terminal wire on the radially outer side.

The first turn portion T1B extends from one end of the first insertion portion S1 in parallel to an oblique-side portion of the third turn portion T23, which is connected to the one end of the third slot insertion portion S3, while maintaining a radial position, and then is bent to extend axially outward. The seventh turn portion T6B is shifted radially outward by the radial thickness of the conductor wire 19 at a crank portion T6Ba after extending from the one end of the sixth slot insertion portion S6, then extends in parallel to an oblique-side portion of the third turn portion T23, which is connected to the one end of the second slot insertion portion S2, while maintaining a radial position, and then is bent to extend axially outward.

As described above, the second winding body 21B is formed similarly to the first winding body 21A except for the first turn portion T1B and the seventh turn portion T6B.

As for the winding body 21, as illustrated in FIG. 9, the first slot insertion portion S1 is inserted at a position of a first layer in the slot 13 having the slot number 7, the second slot insertion portion S2 is inserted at a position of a second layer in the slot 13 having the slot number 1, the third slot insertion portion S3 is inserted at a position of a third layer in the slot 13 having the slot number 7, the fourth slot insertion portion S4 is inserted at a position of a fourth layer in the slot 13 having the slot number 13, the fifth slot insertion portion S5 is inserted at a position of a fifth layer in the slot 13 having the slot number 7, and the sixth slot insertion portion S6 is inserted at a position of a sixth layer in the slot 13 having the slot number 1.

As described above, the same number of winding bodies 21 as the number of slots 13 are arranged on the stator core 11 at one-slot pitches in the circumferential direction. In each of the slots 13, the first slot insertion portion S1, the second slot insertion portion S2, the third slot insertion portion S3, the fourth slot insertion portion S4, the fifth slot insertion portion S5, and the sixth slot insertion portion S6, which are part of three winding bodies 21, are inserted into six layers so as to be arranged in one row in the radial direction. The first layer is a radially innermost layer among the six layers corresponding to the first to six slot insertion portions S1 to S6 inserted so as to be arranged in one row in the slots 13, and the sixth layer is a radially outermost layer.

More specifically, as illustrated in FIG. 10 and FIG. 11, sets each including two first winding bodies 21A and sets each including two second winding bodies 21B are mounted to the stator core 11 at one-slot pitches so as to be arranged alternately in the circumferential direction. As illustrated in FIG. 12, the first winding bodies 21A and the second winding bodies 21B are arranged in an annular shape. As described above, the sets each including two first winding bodies 21A and the sets each including two second winding bodies 21B are arranged at one-slot pitches alternately in the circumferential direction in the annular shape to form a stator winding assembly 20A. Then, the stator winding assembly 20A is mounted to the stator core 11 to form a stator assembly 10A.

With the arrangement described above, on one axial end side of the stator core 11, a layer of the third turn portions T23, in which the third turn portions T23 arranged in the circumferential direction at the one-slot pitches are located, and a layer of the third turn portions T45, in which the fifth turn portions T45 arranged in the circumferential direction at the one-slot pitches are located, are arranged in two layers in the radial direction to form a first coil end 20a. The first turn portions T1A and the first turn portions T1B are arranged in the circumferential direction on a radially inner side of the first coil ends 20a so that a direction of inclination of the oblique-side portions of a set of two first turn portions T1A and a direction of inclination of the oblique-side portions of a set of two first turn portions T1B, which extend from the first layers in the slots 13, are set alternately opposite. The first turn portions T1A and T1B, each extending from a radially inner end side of a corresponding one of the slots 13, are arranged in the circumferential direction. Similarly, the seventh turn portions T6A and the seventh turn portions T6B are arranged in the circumferential direction on a radially outer side of the first coil ends 20a so that a direction of inclination of the oblique-side portions of a set of the seventh turn portions T6A and a direction of inclination of the oblique-side portions of a set of the seventh turn portions T6B, which extend from the sixth layers of the slots 13, are set alternately opposite to each other. The seventh turn portions T7A and T7B, each extending from a radially outer end side of a corresponding one of the slots 13, are arranged in the circumferential direction.

Further, on another axial end side of the stator core 11, a layer of the second turn portions T12, in which the second turn portions T12 are arranged at the one-slot pitches in the circumferential direction, a layer of the fourth turn portions T34, in which the fourth turn portions T34 are arranged at the one-slot pitches in the circumferential direction, and a layer of the sixth turn portions T56, in which the sixth turn portions T56 are arranged at the one-slot pitches in the circumferential direction, are arranged as three layers in the radial direction to form a second coil end 20b.

Then, each of phase windings is formed by joining the first turn portion T1A of the first winding body 21A and the first turn portion T1B of the second winding body 21B, which form the phase winding of the same phase, to each other through, for example, welding and joining the seventh turn portion T6A of the first winding body 21A and the seventh turn portion T6B of the second winding body 21B to each other through, for example, welding. In each of the phase windings, one first winding body 21A is connected to the second winding body 21B being a subject of connection, which is inserted into the slot 13 separate therefrom by a six-slot distance. In this manner, one phase winding is formed by alternately arranging, as illustrated in FIG. 13, three first winding bodies 21A and three second winding bodies 21B in an annular shape.

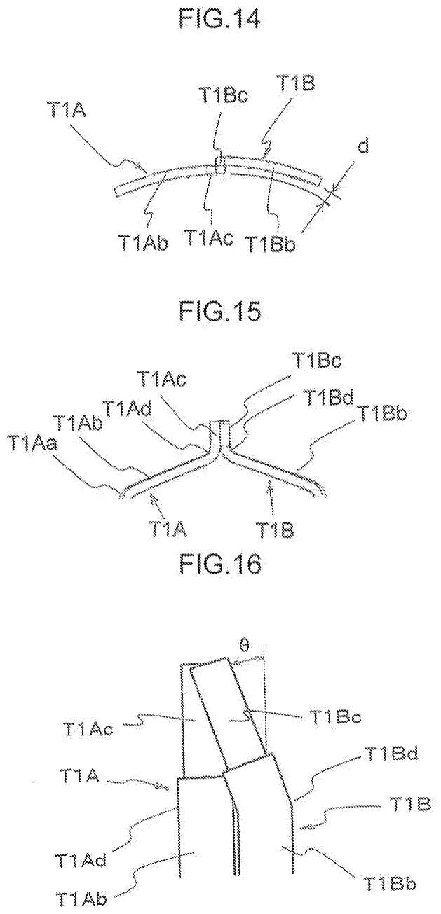

Next, joining between terminals of the winding bodies 21 to each other is described. Joining between the seventh turn portions T6A and T6B of the winding bodies 21 to each other is the same as joining between the first turn portions T1A and T1B to each other. Thus, in this case, only the joining between the first turn portions T1A and T1B to each other is described. FIG. 14 is an end view for illustrating a joint portion of the winding bodies in the stator for a rotating electric machine according to the first embodiment of the present invention when viewed from the axially outer side. FIG. 15 is a plan view for illustrating the joint portion of the winding bodies in the stator for a rotating electric machine according to the first embodiment of the present invention when viewed from the radially inner side. FIG. 16 is a plan view for illustrating the joint portion of the winding bodies in the stator for a rotating electric machine according to the first embodiment of the present invention when viewed in the circumferential direction. In FIG. 14 to FIG. 16, only the first turn portions T1A and T1B are illustrated.

The first turn portion T1A is shifted, as illustrated in FIG. 14 and FIG. 15, radially inward by d, which is a radial thickness of the conductor wire 19, at the crank portion T1Aa after extending from the one end of the first slot insertion portion S1. After that, the first turn portion T1A extends in parallel to the oblique-side portion of the fifth turn portion T45, which is connected to the one end of the fifth slot insertion portion S5, while maintaining a radial position, and then is bent at a bent portion T1Ad to extend axially outward. In this case, a portion from the crank portion T1Aa to the bent portion T1Ad, which extends in parallel to the oblique-side portion of the fifth turn portion T45, the oblique-side portion being connected to the one end of the fifth slot insertion portion S5, while maintaining a radial position, is an oblique-side portion T1Ab. A portion of the first turn portion T1A, which extends axially outward from the bent portion T1Ad of the first turn portion T1A to a distal end, is a straight portion T1Ac. The bent portion T1Ad is formed at a boundary portion between the oblique-side portion T1Ab of the first turn portion T1A and the straight portion T1Ac.

The first turn portion T1B extends from the one end of the first slot insertion portion S1 in parallel to the oblique-side portion of the third turn portion T23, which is connected to the one end of the third slot insertion portion S3, while maintaining a radial position. After that, the first turn portion T1B is bent at a bent portion T1Bd to extend axially outward. A portion of the first turn portion T1B from the bent portion T1Bd to a distal end thereof is further bent radially inward at the bent portion T1Bd, specifically, so as to approach the straight portion T1Ac. A straight portion T1Bc is bent, as illustrated in FIG. 16, radially inward at the bent portion T1Bd by an angle θ. As a result, a distal end portion of the straight portion T1Bc is shifted radially inward by the radial thickness of the conductor wire with respect to a boundary portion between an oblique-side portion T1Bb and a straight portion T1Bc. In this case, a portion extending from the one end of the first slot insertion portion S1 in parallel to the oblique-side portion of the third turn portion T23, which is connected to the one end of the third slot insertion portion S3, while maintaining a radial position, is the oblique-side portion T1Bb. Further, a portion of the first turn portion T1B, which extends from the bent portion T1Bd of the first turn portion T1B to a distal end, is a straight portion T1Bc. The bent portion T1Bd is formed at a boundary portion between the oblique-side portion T1Bb of the first turn portion T1B and the straight portion T1Bc.

With the configuration described above, a distal end portion of the straight portion T1Ac and the distal end portion of the straight portion T1Bc are brought into an overlapping state when viewed in the circumferential direction. Further, the distal end portion of the straight portion T1Ac and the distal end portion of the straight portion T1Bc are, as illustrated in FIG. 15, parallel to each other and held in a contact state when viewed in the radial direction. Then, the straight portions T1Ac and T1Bc are joined to each other through, for example, TIG welding and electrically connected to each other under a state in which surfaces opposed to each other in the circumferential direction are held in contact with each other. In this case, bending in the axial direction for bending the straight portion T1Bc so that the straight portion T1Bc extends in the axial direction and bending in the radial direction for bending the straight portion T1Bc in the radial direction are achieved through the same bent portion T1Bd. However, the bending in the axial direction and the bending in the radial direction may be achieved through different bent portions, respectively. In this case, a bent portion for bending in the radial direction is located on a distal end side with respect to a bent portion for bending in the axial direction.

In the related art, the distal end side of each of the straight portions is bent into a crank shape. Hence, the distal end portions to be welded to each other are required to be bent twice in the radial direction. Further, a bending angle at each of the bent portions is 90 degrees. As a result, damage to the insulation coating of the conductor wire may occur. When a curvature radius at each of the bent portions is increased so as to suppress the occurrence of the damage to the insulation coating, a distance of the weld portion from an end surface of the stator core is increased.

According to the first embodiment, the first turn portion T1A is not bent in the radial direction at the bent portion T1Ad.

The first turn portion T1B is bent from a state of extending in the axial direction so as to be inclined in the radial direction through the bent portion T1Bd at the boundary portion between the oblique-side portion T1Bb and the straight portion T1Bc so that the distal end portion of the straight portion T1Bc of the first turn portion T1B overlaps with the distal end portion of the straight portion T1Ac of the first turn portion T1A when viewed in the circumferential direction. Thus, the first turn portion T1B is bent once in the radial direction at the bent portion T1Bd. Further, the bending angle θ of the bent portion T1Bd in the radial direction is reduced. As a result, the occurrence of damage to the insulation coating at the bent portion T1Bd is suppressed, and hence an insulating property is improved. Further, the curvature radius at the bent portion T1Bd is not required to be increased, and the distance of the weld portion from the end surface of the stator core is not required to be increased. As a result, increase in axial dimension of the stator 10 is suppressed, and thus downsizing of the stator 10 is achieved.

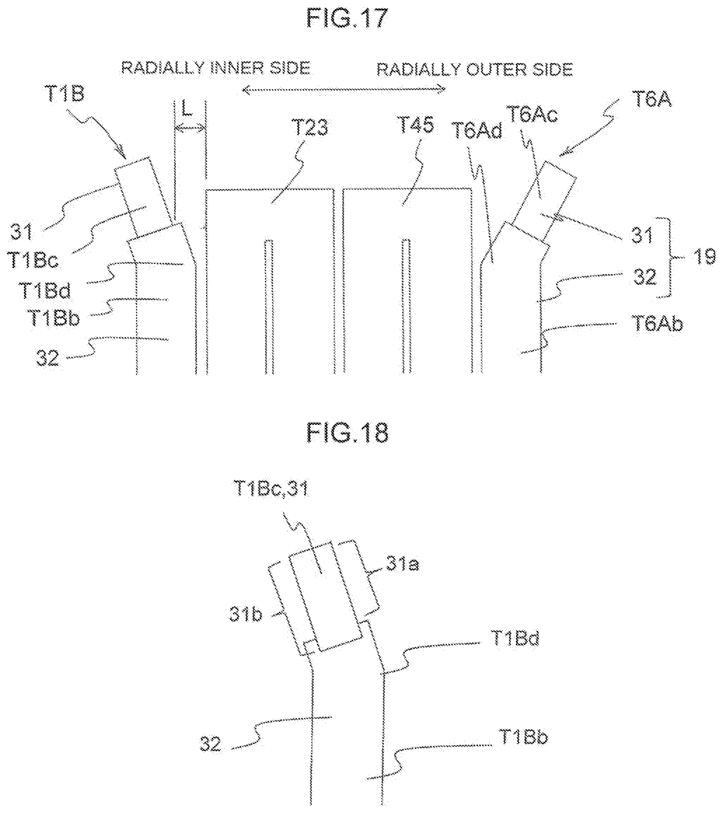

The conductor wire 19 is formed by covering a conductor bare wire with an insulation coating 32. The insulation coating 32 is removed from a distal end side of a radially inner side terminal and a distal end side of a radially outer side terminal of the winding body 21. In the first turn portion T1B of each of the winding bodies 21, as illustrated in FIG. 17, an insulation-coating removed portion 31 in which the conductor bare wire of the straight portion T1Bc of the winding body 21 is exposed is located on the distal end side with respect to the bent portion T1Bd, which is the boundary portion between the oblique-side portion T1Bb and the straight portion T1Bc. With the position described above, a radial distance L between the insulation-coating removed portion 31 in the straight portion T1Bc of the first turn portion T1B and the third turn portion T23 is increased to improve the insulating property. Even in the seventh turn portion T6A, the insulation-coating removed portion 31 in the straight portion T6Ac is located on the distal end side with respect to the bent portion T6Ad. As a result, a radial distance between the insulation-coating removed portion 31 in the straight portion T6Ac of the seventh turn portion T6A and the fifth turn portion T45 is increased to improve the insulating property.

Further, when a pair of flat surfaces of the straight portion T1Bc having a rectangular cross section, which are on the sides opposite to each other, are oriented in the radial direction, and another pair of flat surfaces thereof, which are on the sides opposite to each other, are oriented in the circumferential direction, as illustrated in FIG. 18, a length of insulation-coating removed portions 31a on the pair of flat surfaces oriented in the radial direction may be set smaller than a length of insulation-coating removed portions 31b on the pair of flat surfaces oriented in the circumferential direction. In this case, the radial distance L between the insulation-coating removed portion 31a in the straight portion T1Bc of the first turn portion T1B and the third turn portion T23 is further increased to further improve the insulating property.

In each of the first turn portion T1A and the seventh turn portion T6B, which are not inclined in the radial direction, the length of the flat surfaces of the insulation-coating removed portion 31a, which are oriented in the radial direction, may be set equal to the length of the flat surfaces of the insulation-coating removed portion 31b, which are oriented in the circumferential direction, or may be set shorter than the length of the flat surfaces of the insulation-coating removed portion 31b, which are oriented in the circumferential direction.

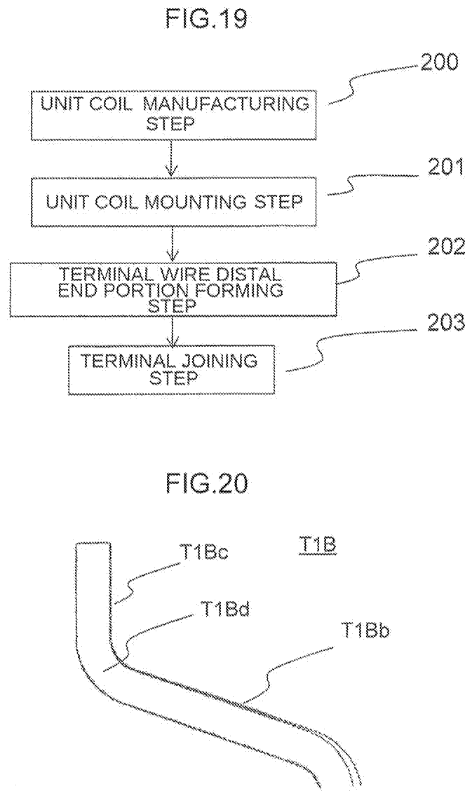

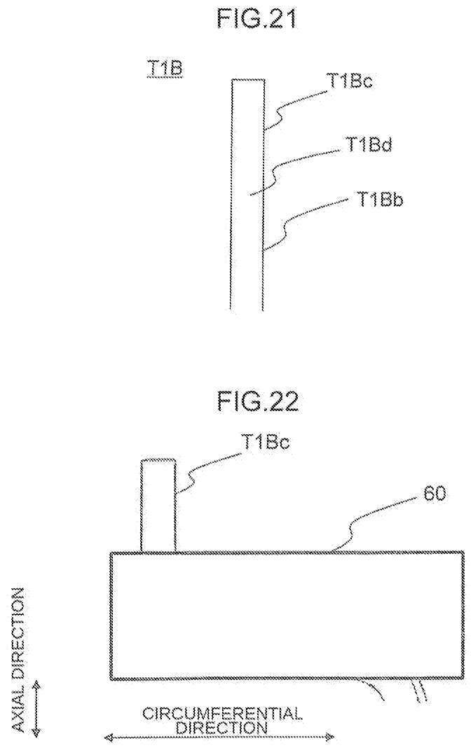

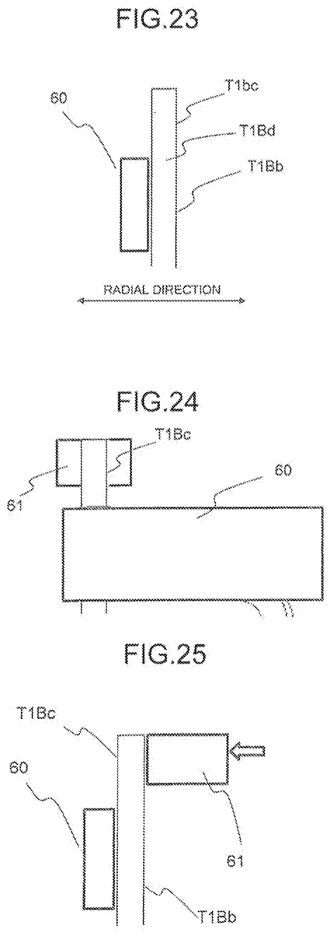

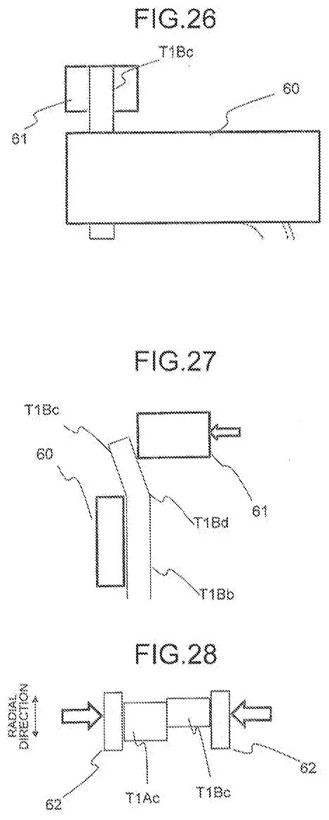

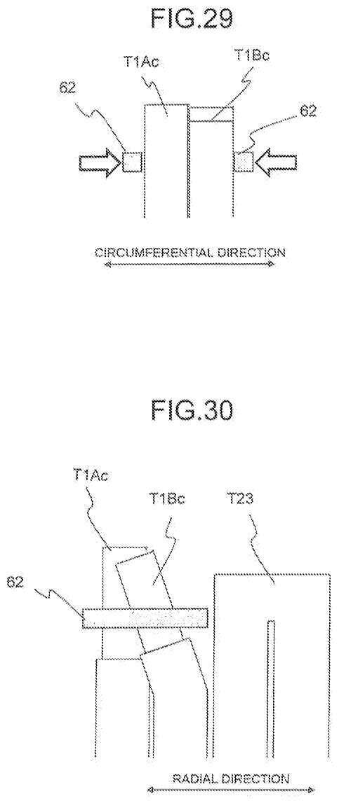

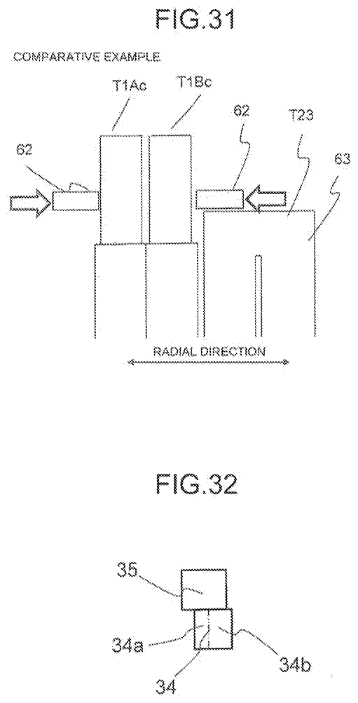

Next, a method of manufacturing the stator 10 is described. FIG. 19 is a flowchart for illustrating the method of manufacturing the stator for a rotating electric machine according to the first embodiment of the present invention. FIG. 20 is a plan view for illustrating the first turn portion in the stator for a rotating electric machine according to the first embodiment of the present invention when viewed from the radially inner side. FIG. 21 is a plan view for illustrating the first turn portion in the stator for a rotating electric machine according to the first embodiment of the present invention when viewed in the circumferential direction. FIG. 22 to FIG. 27 are views for illustrating a terminal wire distal end portion forming step in the stator for a rotating electric machine according to the first embodiment of the present invention. FIG. 22 is a plan view for illustrating a state in which a holding tool is placed so as to be held in contact with the first turn portion when viewed from the radially inner side. FIG. 23 is a plan view for illustrating the state in which the holding tool is placed so as to be held in contact with the first turn portion when viewed in the circumferential direction. FIG. 24 is a plan view for illustrating a state in which a bending tool is placed so as to be held in contact with the first turn portion when viewed from the radially inner side. FIG. 25 is a plan view for illustrating the state in which the bending tool is placed so as to be held in contact with the first turn portion when viewed in the circumferential direction. FIG. 26 is a plan view for illustrating a state in which the first turn portion is bent with use of the bending tool when viewed from the radially inner side. FIG. 27 is a plan view for illustrating the state in which the first turn portion is bent with use of the bending tool when viewed in the circumferential direction. FIG. 28 to FIG. 30 are views, each for illustrating a terminal joining step in the stator for a rotating electric machine according to the first embodiment of the present invention. FIG. 28 is plan view for illustrating a state in which the straight portions are held with chucks when viewed from the axially outer side. FIG. 29 is a plan view for illustrating the state in which the straight portions are held with the chucks when viewed from the radially inner side. FIG. 30 is a plan view for illustrating the state in which the straight portions are held with the chucks when viewed in the circumferential direction. FIG. 31 is a plan view for illustrating a state in which straight portions in a stator of a comparative example are held with chucks when viewed in the circumferential direction.

The method of manufacturing the stator 10 includes, as illustrated in FIG. 19, a unit coil manufacturing step 200, a unit coil mounting step 201, a terminal wire distal end portion forming step 202, and a terminal joining step 203. In the unit coil manufacturing step 200, the winding bodies 21 are manufactured. In the unit coil mounting step 201, the winding bodies 21 are mounted to the stator core 11. In the terminal wire distal end portion forming step 202, the terminal wire distal end portion of each of the winding bodies 21 mounted to the stator core 11 is bent. In the terminal joining step 203, the terminals of the winding bodies 21 are joined to each other.

In the unit coil manufacturing step 200, the conductor wire 19 is bent to manufacture each of the first winding body 21A and the second winding body 21B, which are illustrated in FIG. 6 to FIG. 9.

In the unit coil mounting step 201, first, forty-eight first winding bodies 21A and second winding bodies 21B are arranged at one-slot pitches so that sets each including two first winding bodies 21A and sets each including two second winding bodies 21B are alternately arranged in the circumferential direction to thereby manufacture the winding assembly 20A having the annular shape illustrated in FIG. 12. The winding assembly 20A is formed by arranging forty-eight slot insertion portion rows, each including six slot insertion portions S1 to S6 arranged in one row in the radial direction, at one-slot pitches in the circumferential direction. Subsequently, the teeth 12b of the core blocks 12 are inserted into spaces between the slot insertion portion rows from the radially outer side of the winding assembly 20A, respectively, so that the forty-eight core blocks 12 are mounted to the winding assembly 20A. Subsequently, the forty-eight core blocks 12, which are arranged in the annular shape while circumferential side surfaces of the core back portions 12a are held in abutment against each other, are inserted into and retained in the cylindrical portion of the frame 2 through, for example, press-fitting or shrink-fitting. As a result, the winding assembly 20A is mounted to the stator core 11 to thereby assemble the stator assembly 10A illustrated in FIG. 10.

In the terminal wire distal end portion forming step 202, the straight portion T1Bc of the first turn portion T1B and the straight portion T6Ac of the seventh turn portion T6A are bent in the radial direction. In this case, the straight portion T1Bc of the first turn portion T1B is described. The first turn portion T1B has, as illustrated in FIG. 20 and FIG. 21, the oblique-side portion T1Bb, the straight portion T1Bc, and the bent portion T1Bd. The straight portion T1Bc extends in the axial direction. Further, the first turn portion T1B is formed, as illustrated in FIG. 21, linearly in the axial direction when viewed in the circumferential direction.

First, as illustrated in FIG. 22 and FIG. 23, a holding tool 60 is brought into contact with the oblique-side portion T1Bb of the first turn portion T1B from the radially inner side. Subsequently, as illustrated in FIG. 24 and FIG. 25, a bending tool 61 is brought into contact with the straight portion T1Bc from the radially outer side so as to press the straight portion T1Bc toward the radially inner side. As a result, as illustrated in FIG. 26 and FIG. 27, the straight portion T1Bc is inclined radially inward at the bent portion T1Bd as a bending center to thereby form the terminal wire distal end portion. The straight portion T6Ac of the seventh turn portion T6A is inclined radially outward at the bent portion T6Ad as a bending center to thereby form the terminal wide distal end portion.

In the terminal joining step 203, the straight portion T1Ac of the first turn portion T1A and the straight portion T1Bc of the first turn portion T1B are joined to each other, and the straight portion T6Ac of the seventh turn portion T6A and the straight portion T6Bc of the seventh turn portion T6B are joined to each other. In this case, the joining between the straight portion T1Ac of the first turn portion T1A and the straight portion T1Bc of the first turn portion T1B is described.

The distal end portion of the straight portion T1Ac of the first turn portion T1A and the distal end portion of the straight portion T1Bc of the first turn portion T1B are arranged in an overlapping state when viewed in the circumferential direction. Thus, as illustrated in FIG. 28 to FIG. 30, the distal end portion of the straight portion T1Ac and the distal end portion of the straight portion T1Bc are clamped and retained by a pair of chucks 62 from both sides in the circumferential direction. Then, the distal end portion of the straight portion T1Ac and the distal end portion of the straight portion T1Bc are welded to each other from the axially outer side to electrically connect the winding bodies 21 to each other. Similarly, the straight portion T6Ac of the seventh turn portion T6A and the straight portion T6Bc of the seventh turn portion T6B are joined to each other to electrically connect the winding bodies 21 to each other. In this manner, the winding bodies 21 for forming the stator winding assembly 20A are electrically connected to thereby form the stator winding 20. Then, the stator 10 illustrated in FIG. 3, in which the stator winding 20 is mounted to the stator core 11, is manufactured.

As illustrated in FIG. 31, when the straight portions T1Ac and T1Bc are formed so as to be brought into contact with each other in the radial direction, the straight portions T1Ac and T1Bc are clamped and retained by the pair of chucks 62 in the radial direction. Thus, in order to avoid interference between the pair of chucks 62 and the third turn portion T23, the straight portions T1Ac and T1Bc are required to be extended in the axial direction. Thus, an axial dimension of the stator is increased.

In the first embodiment, the straight portions T1Ac and T1Bc are formed so that the surfaces opposed to each other in the circumferential direction are brought into contact with each other. In this manner, the straight portions T1Ac and T1Bc can be clamped and retained by the pair of chucks 62 in the circumferential direction without being interfered by the third turn portion T23. As a result, when the straight portions T1Ac and T1Bc are clamped and retained, the straight portions T1Ac and T1Bc are not required to be extended in the axial direction so as to avoid the interference with the third turn portion T23. Thus, increase of the stator 10 in the axial direction can be suppressed.

Further, the straight portion T1Bc is inclined toward the radially inner side at the bent portion T1Bd. As a result, the weld portion between the straight portions T1Ac and T1Bc separates from the third turn portion T23. Thus, occurrence of damage to the insulation coating of the third turn portion T23 by heat at the time of welding of the straight portions T1Ac and T1Bc is suppressed.

Further, the terminal wire distal end portion forming step 202 is carried out under a state in which the winding bodies 21 are mounted to the stator core 11. Thus, a formation variation can be reduced, and hence the terminal joining step 203 can easily be carried out.

In the first embodiment described above, in the terminal wire distal end portion forming step 202 after the winding bodies are mounted to the stator core, only the bending of the first turn portion and the seventh turn portion of the winding bodies in the radial direction is performed. However, in the terminal wire distal end portion forming step 202, the bending of the first turn portion and the seventh turn portion of the winding bodies in both of the directions may be performed.

### Second Embodiment

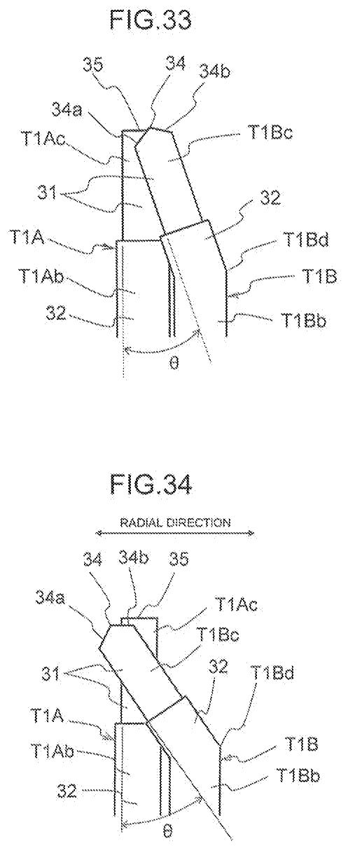

FIG. 32 is an end view for illustrating a terminal wire connection portion of the winding bodies in the stator for a rotating electric machine according to a second embodiment of the present invention when viewed from the axially outer side. FIG. 33 is a plan view for illustrating the terminal wire connection portion of the winding bodies according to one aspect of the stator for a rotating electric machine according to the second embodiment of the present invention.

In FIG. 32 and FIG. 33, a distal end surface of the straight portion T1Bc of the first turn portion T1B having the boundary portion between the straight portion T1Bc and the oblique-side portion T1Bb of the first turn portion T1B as the bent portion T1Bd in the radial direction is formed in an inverted V shape. The inverted V shape has a slope 34a on the radially inner side and a slope 34b on the radially outer side, which cross each other at a ridge line 34. The ridge line 34 on the distal end surface of the straight portion T1Bc extends in the circumferential direction. The ridge line 34 on the distal end surface of the straight portion T1Bc intersects with a region of a flat surface 35 being a distal end surface of the straight portion T1Ac of the first turn portion T1A, with which the straight portion T1Bc is held in contact, when viewed from the axially outer side. Specifically, the ridge line 34 on the distal end surface of the straight portion T1Bc is located so as to fall within a region in which the distal end portion of the straight portion T1Ac and the distal end portion of the straight portion T1Bc overlap with each other when viewed in the circumferential direction.

Although not shown, even in a connection portion between the straight portion T6Ac of the seventh turn portion T6A of the winding body 21 and the straight portion T6Bc of the seventh turn portion T6B of the winding body 21, which are to be joined to each other, a distal end surface of the straight portion T6Ac is formed in an inverted V shape. A ridge line on the distal end surface of the straight portion T6Ac is located so as to fall within a region in which the distal end portion of the straight portion T6Ac and the distal end portion of the straight portion T6Bc overlap with each other when viewed in the circumferential direction. Specifically, the straight portions T6Ac and T6Bc are formed in the same manner as the straight portions T1Ac and T1Bc, and are connected to each other in the same manner.

Other configurations are the same as those of the first embodiment described above.

Even in the second embodiment, the same effects as those of the first embodiment described above are attained.

According to the second embodiment, a level difference between the distal end surface of the straight portion T1Ac and the distal end surface of the straight portion T1Bc is reduced. Thus, a satisfactory welded state can be guaranteed, and a stable connected state can be ensured.

### Third Embodiment

FIG. 34 is a plan view for illustrating the terminal wire connection portion of the winding bodies according to one aspect of the stator for a rotating electric machine according to the third embodiment of the present invention.

In FIG. 34, a distal end surface of the straight portion T1Bc of the first turn portion T1B having the boundary portion between the straight portion T1Bc and the oblique-side portion T1Bb of the first turn portion T1B as the bent portion T1Bd in the radial direction is formed in an inverted V shape. The inverted V shape has the slope 34a on the radially inner side and the slope 34b on the radially outer side, which cross each other at the ridge line 34. The ridge line 34 on the distal end surface of the straight portion T1Bc extends in the circumferential direction. The straight portion T1Bc is bent radially inward at the bent portion T1Bd by the angle θ. With the bending described above, the distal end portion of the straight portion T1Bc is shifted radially inward by a distance larger than the radial thickness of the conductor wire with respect to the boundary portion between the oblique-side portion T1Bb and the straight portion T1Bc. The ridge line 34 on the distal end surface of the straight portion T1Bc is located on the radially inner side with respect to the straight portion T1Ac of the first turn portion T1A when viewed in the circumferential direction. An intersecting portion between the distal end surface of the inverted V shape of the straight portion T1Bc and a side surface of the straight portion T1Bc, which is located on a side opposite to the bending direction of the bent portion T1Bd in the radial direction, is located so as to fall within the region in which the distal end portion of the straight portion T1Ac and the distal end portion of the straight portion T1Bc overlap with each other when viewed in the circumferential direction.

Although not shown, the seventh turn portion T6A of the winding body 21 and the seventh turn portion T6B of the winding body 21, which are to be joined, are formed in the same manner as the first turn portions T1A and T1B, which are to be connected to each other, and are to be connected in the same manner.

Other configurations are the same as those of the first embodiment described above.

Even in the third embodiment, the same effects as those of the first embodiment described above are attained.

According to the third embodiment, a level difference between the distal end surface of the straight portion T1Ac and the distal end surface of the straight portion T1Bc is reduced. Thus, a satisfactory welded state can be guaranteed, and a stable connected state can be ensured.

Further, the distal end side of the straight portion T1Bc projects radially inward from the straight portion T1Ac. Thus, at the time of welding, a range for chucking the straight portions T1Ac and T1Bc can be set large. As a result, a stable connected state can be ensured.

### Fourth Embodiment

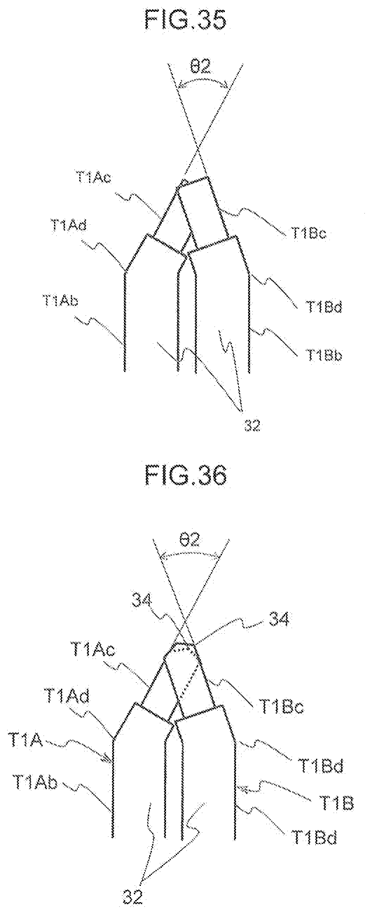

FIG. 35 is a plan view for illustrating the terminal wire connection portion of the winding bodies according to one aspect of the stator for a rotating electric machine according to the fourth embodiment of the present invention.

In FIG. 35, the straight portion T1Ac of the first turn portion T1A is bent radially outward through the bent portion T1Ad at the boundary portion between the oblique-side portion T1Ab and the straight portion T1Ac so as to be inclined in a direction closer to the straight portion T1Bc of the first turn portion T1B. The distal end portion of the straight portion T1Ac is shifted radially outward by half of the radial thickness of the conductor wire with respect to the boundary portion between the oblique-side portion T1Ab and the straight portion T1Ac. The straight portion T1Bc of the first turn portion T1B is bent radially inward through the bent portion T1Bd at the boundary portion between the oblique-side portion T1Bb and the straight portion T1Bc so as to be inclined in a direction closer to the straight portion T1Ac of the first turn portion T1A. The distal end portion of the straight portion T1Bc is shifted radially inward by half of the radial thickness of the conductor wire with respect to the boundary portion between the oblique-side portion T1Bb and the straight portion T1Bc. The distal end portion of the straight portion T1Ac of the first turn portion T1A and the distal end portion of the straight portion T1Bc of the first turn portion T1B, which are located on the radially inner end side of the slots, intersect with each other at an angle θ2 when viewed in the circumferential direction. Specifically, the distal end portion of the straight portion T1Ac and the distal end portion of the straight portion T1Bc overlap with each other when viewed in the circumferential direction. Further, although not shown, the straight portion T6Ac of the seventh turn portion T6A and the straight portion T6Bc of the seventh turn portion T6B, which are located on the radially outer end side of the slots, have the same configuration. Specifically, the distal end portion of the straight portion T6Ac and the distal end portion of the straight portion T6Bc overlap with each other when viewed in the circumferential direction.

Other configurations are the same as those of the first embodiment described above.

Even in the fourth embodiment, each of a set of the straight portions T1Ac and T1Bc and a set of the straight portions T6Ac and T6Bc are clamped and retained by the chucks in the circumferential direction under a state in which the distal end portions thereof overlap with each other, and each of the sets is joined through, for example, TIG welding.

In the fourth embodiment, the straight portions T1Ac and T1Bc and the straight portions T6Ac and T6Bc are inclined so that the straight portions T1Ac and T1Bc are brought closer to each other and the straight portions T6Ac and T6Bc are brought closer to each other. Thus, the bending angle in the radial direction at the bent portion is reduced. As a result, the occurrence of damage to the insulation coating 32 is suppressed. Further, a distance of the joint portion between the straight portions T1Ac and T1Bc from the stator core and a distance of the joint portion between the straight portions T6Ac and T6Bc from the stator core are reduced, and the axial dimension of the stator can be reduced.

Even in the fourth embodiment, as illustrated in FIG. 18, a length of the insulation-coating removed portions in each of the straight portions T1Ac, T1Bc, T6Ac, and T6Bc, which are formed on the surfaces oriented in the radial direction, may be set shorter than a length of the insulation-coating removed portions thereof, which are formed on the surfaces oriented in the circumferential direction. Each of the end surfaces of the straight portions T1Ac, T1Bc, T6Ac, and T6Bc may be formed in an inverted V shape as described above with reference to FIG. 19.

Further, as illustrated in FIG. 36, each of the distal end surfaces of the straight portions T1Ac and T1Bc may be formed in an inverted V shape. In this case, the ridge lines 34 on the distal end surfaces of the straight portions T1Ac and T1Bc, specifically, apices at distal ends thereof are brought closer to each other. Thus, in the TIG welding, a position of an arc becomes stable. As a result, a stable connected state can be ensured.

### Fifth Embodiment

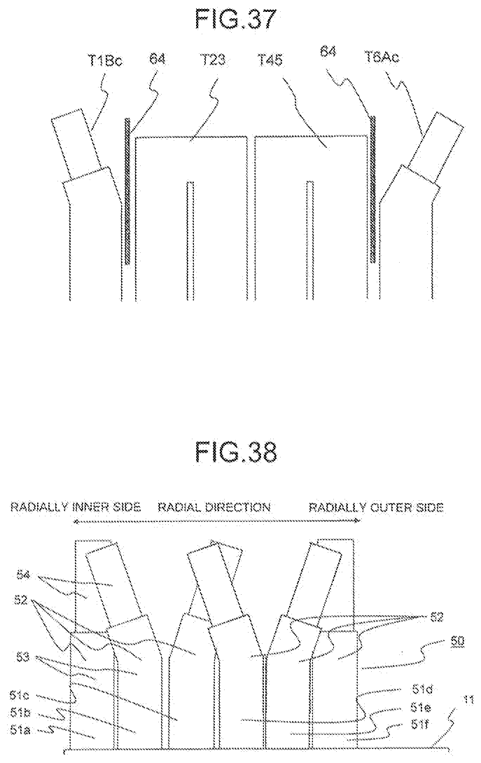

FIG. 37 is a schematic view for illustrating the first coil end in the stator for a rotating electric machine according to a fifth embodiment of the present invention.

In FIG. 37, an insulating member 64 is provided between the first turn portions T1A and T1B located on the radially inner end side of the slots and the third turn portion T23 located on the radially outer side of the first turn portions T1A and T1B, and an insulating member 64 is provided between the seventh turn portions T6A and T6B located on the radially outer end side of the slots and the fifth turn portion 45 located on the radially inner side of the seventh turn portions T6A and T6B. Each of the insulating members 64 is, for example, a sheet made of a polyphenylenesulfide (PPS) resin having a thickness falling within a range of from 0.1 mm to 0.5 mm.

Other configurations are the same as those of the first to fourth embodiments described above.

According to the fifth embodiment, an insulating property between the weld portion between the first turn portions T1A and T1B and the third turn portion T23 and between the weld portions between the seventh turn portions T6A and T6B and the fifth turn portion T45 are enhanced. As a result, the insulation-coating removed portion 31 can be formed so as to extend toward the stator core 11 side beyond the bent portions T1Bd and T6Ad.

### Sixth Embodiment

FIG. 38 is a schematic view for illustrating a terminal wire connection portion in a stator for a rotating electric machine according to a sixth embodiment of the present invention when viewed in a circumferential direction of the stator.

In the first to fifth embodiments described above, each winding body 21, which has a coil pattern resembling the shape of “8” turned sideways when viewed from the radially inner side, is used as a unit coil. In the sixth embodiment, however, each segment coil 50 having a U shape is used as a unit coil.

The segment coil 50 is formed in a U shape by connecting a pair of slot insertion portions with a turn portion, and is manufactured by bending the conductor wire covered with the insulation coating. The segment coil 50 is, for example, inserted into a pair of slots, which are located on both sides of six teeth continuous in the circumferential direction, from one ends in the axial direction. In this case, insertion positions of the slot insertion portions in the slot are referred to as a first layer, a second layer, . . . , and a sixth layer from the radially inner side. The segment coil 50 is inserted into a first layer of one of the pair of slots and a second layer of another one of the pair of slots, and the segment coils 50 are arranged at one-slot pitches in the circumferential direction. Further, the segment coil 50 is inserted into a third layer of one of the pair of slots and a fourth layer of another one of the pair of slots, and the segment coils 50 are arranged at one-slot pitches in the circumferential direction. Further, the segment coil 50 is inserted into a fifth layer of one of the pair of slots and a sixth layer of another one of the pair of slots, and the segment coils 50 are arranged at one-slot pitches in the circumferential direction. With the arrangement described above, a plurality of the segment coils 50 are mounted to the stator core 11.

In each of the slots, six slot insertion portions are inserted while being arranged in one row in the radial direction. Two terminal wires of the segment coil 50 project from the pair of slots to another side in the axial direction. Each of the terminal wires of the segment coil 50 includes an oblique-side portion 53 and a straight portion 54. The oblique-side portions 53 of the terminal wires of the segment coil 50 are bent so as to be inclined opposite to each other in the circumferential direction. Each of the straight portions 54 is bent at a bent portion 52 to extend in the axial direction. In this case, a terminal wire 51a projecting from the first layer in the slot and a terminal wire 51b projecting from the second layer are terminal wires on the radially inner end side of the slot. A terminal wire 51e projecting from the fifth layer in the slot and a terminal wire 51f projecting from the sixth layer are terminal wires on the radially outer end side of the slot. A terminal wire 51c projecting from the third layer in the slot and a terminal wire 51d projecting from the fourth layer are terminal wires in the intermediate region of the slot.

The oblique-side portion 53 of the terminal wire 51b projecting form the second layer in the slot is shifted radially outward by the radial thickness of the conductor wire with respect to the oblique-side portion 53 of the terminal wire 51a projecting from the first layer in the slot. The terminal wire 51b is bent so as to be further inclined radially inward through the bent portion 52 at the boundary portion between the oblique-side portion 53 and the straight portion 54. In this manner, the distal end portion of the straight portion 54 of the terminal wire 51b is shifted radially inward by the radial thickness of the conductor wire with respect to the boundary portion between the oblique-side portion 53 and the straight portion 54. As a result, the distal end portion of the straight portion 54 of the terminal wire 51b overlaps with the distal end portion of the straight portion 54 of the terminal wire 51a, which projects from the first layer in the slot, when viewed in the circumferential direction. Although not shown, similarly to the first embodiment, the distal end portions of the straight portions 54 of the terminal wires 51a and 51b are clamped and retained by the pair of chucks in the circumferential direction, and joined to each other through, for example, TIG welding.

Further, the oblique-side portion 53 of the terminal wire 51e projecting form the fifth layer in the slot is shifted radially inward by the radial thickness of the conductor wire with respect to the oblique-side portion 53 of the terminal wire 51f projecting from the sixth layer in the slot. The terminal wire 51e is bent so as to be further inclined radially outward through the bent portion 52 at the boundary portion between the oblique-side portion 53 and the straight portion 54. In this manner, the distal end portion of the straight portion 54 of the terminal wire 51e is shifted radially outward by the radial thickness of the conductor wire with respect to the boundary portion between the oblique-side portion 53 and the straight portion 54. As a result, the distal end portion of the straight portion 54 of the terminal wire 51e overlaps with the distal end portion of the straight portion 54 of the terminal wire 51f, which projects from the sixth layer in the slot, when viewed in the circumferential direction. The distal end portions of the straight portions 54 of the terminal wires 51c and 51d are clamped and retained by the pair of chucks in the circumferential direction, and joined to each other through, for example, TIG welding.

Further, the oblique-side portion 53 of the terminal wire 51d projecting from the fourth layer in the slot is shifted radially outward by the radial thickness of the conductor wire with respect to the oblique-side portion 53 of the terminal wire 51c projecting from the third layer in the slot. The terminal wire 51c projecting from the third layer in the slot is bent through the bent portion 52 at the boundary portion between the oblique-side portion 53 and the straight portion 54 so as to be further inclined radially outward. In this manner, the distal end portion of the straight portion 54 of the terminal wire 51c is shifted radially outward by half of the radial thickness of the conductor wire with respect to the boundary portion between the oblique-side portion 53 and the straight portion 54. The terminal wire 51d projecting from the fourth layer in the slot is bent through the bent portion 52 at the boundary portion between the oblique-side portion 53 and the straight portion 54 so as to be further inclined radially inward. In this manner, the distal end portion of the straight portion 54 of the terminal wire 51d is shifted radially inward by half of the radial thickness of the conductor wire with respect to the boundary portion between the oblique-side portion 53 and the straight portion 54. As a result, the distal end portions of the straight portions 54 of the terminal wires 51c and 51d overlap with each other when viewed in the circumferential direction. The distal end portions of the straight portions 54 of the terminal wires 51c and 51d are clamped and retained by the pair of chucks in the circumferential direction, and are joined to each other through, for example, TIG welding.

Thus, even in the sixth embodiment, the same effects as those of the first embodiment described above are attained.

In the sixth embodiment, the terminal wire 51c projecting from the third layer and the terminal wire 51d projecting from the fourth layer in the slot are bent in the radial direction at the bent portions 52 to be inclined so as to approach each other. Thus, a distance between the weld portions, which are adjacent to each other in the radial direction, is increased to improve the insulating property.

Even in the sixth embodiment described above, an end surface of each of the terminal wires may be formed in an inverted V shape as described in the second to fourth embodiments. Further, as illustrated in FIG. 18, the length of the insulation-coating removed portion formed on each of the flat surfaces of the terminal wire, which are oriented in the radial direction, may be set shorter than the length of the insulation-coating removed portion formed on each of the flat surfaces of the terminal wire, which are oriented in the circumferential direction.

Further, even in the sixth embodiment, the bending of the distal end portion of the terminal wire can be performed through the terminal wire distal end portion forming step in the first embodiment described above.

### Seventh Embodiment

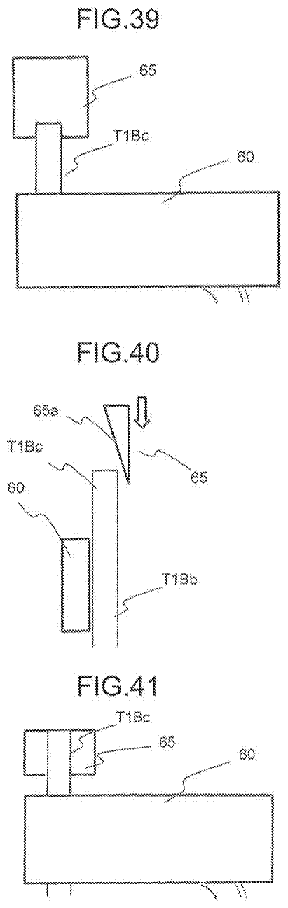

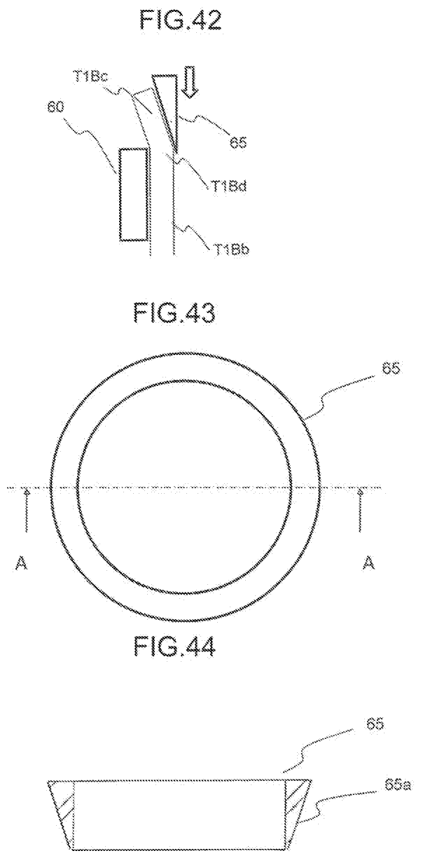

FIG. 39 to FIG. 42 are views for illustrating the terminal wire distal end portion forming step in a stator for a rotating electric machine according to a seventh embodiment of the present invention. FIG. 39 is a plan view for illustrating a state in which the holding tool and the bending tool are placed so as to be held in contact with the first turn portion when viewed from the radially inner side. FIG. 40 is a plan view for illustrating the state in which the holding tool and the bending tool are placed so as to be held in contact with the first turn portion when viewed in the circumferential direction. FIG. 41 is a plan view for illustrating a state in which the first turn portion is bent with use of the bending tool when viewed from the radially inner side. FIG. 42 is a plan view for illustrating the state in which the first turn portion is bent with use of the bending tool when viewed in the circumferential direction. FIG. 43 is a plan view for illustrating the bending tool in the stator for a rotating electric machine according to the seventh embodiment of the present invention. FIG. 44 is a sectional view taken along the line A-A of FIG. 43 when viewed in the direction indicated by the arrows.

Configurations of the seventh embodiment are the same as those of the first embodiment except that the terminal wire distal end portion forming step is different.

A bending tool 65 is formed in, as illustrated in FIG. 43 and FIG. 44, a ring shape having an outer peripheral surface 65a as an outer peripheral surface of a truncated conical shape, specifically, a ring shape having a wedge-like shape.

First, as in the first embodiment, the winding bodies 21 are mounted to the stator core 11 in the unit coil mounting step 201.

Subsequently, in the terminal wire distal end portion forming step, first, as illustrated in FIG. 39 and FIG. 40, the holding tool 60 is brought into contact with the oblique-side portion T1Bb of the first turn portion T1B from the radially inner side, and the bending tool 65 is arranged on the axially outer side of the first turn portion T1B. Next, as illustrated in FIG. 41 and FIG. 42, the bending tool 65 is moved toward the stator core side in the axial direction. As a result, the bending tool 65 is inserted into the side of the straight portion T1Bc, which is opposite to the holding tool 60, and is moved toward the stator core side so as to push out the straight portion T1Bc with the outer peripheral surface 65a. At this time, the holding tool 60 is placed so as to be held in contact with the oblique-side portion T1Bb of the first turn portion T1B. Thus, the straight portion T1Bc is inclined radially inward at the bent portion T1Bd as a bending center to thereby form the terminal wire distal end portion. The straight portion T6Ac of the seventh turn portion T6A is inclined radially outward at the bent portion T6Ad as a bending center with use of the bending tool having the ring shape with the inner peripheral surface serving as the inner peripheral surface of the truncated conical shape. As a result, the terminal wire distal end portion can be formed.

Subsequently, as in the first embodiment, in the terminal joining step 203, the straight portion T1Ac of the first turn portion T1A and the straight portion T1Bc of the first turn portion T1B are joined to each other, and the straight portion T6Ac of the seventh turn portion T6A and the straight portion T6Bc of the seventh turn portion T6B are joined to each other.

According to the seventh embodiment, only through the movement of the bending tool 65 in the axial direction, the straight portions T1Bc of the plurality of first turn portions T1B, which are arranged in the circumferential direction, can be bent in the radial direction simultaneously. Thus, time taken for the terminal wire distal end portion forming step can be significantly shortened.

In the seventh embodiment described above, the terminal wire distal end portion forming step has been described with use of the stator according to the first embodiment. However, the terminal wire distal portion forming step may be applied to the stator according to another one of the embodiments.

In the embodiments described above, the winding body 21 having the coil pattern resembling the shape of “8” turned sideways or the segment coil 50 having the U shape when viewed from the radially inner side is used. However, the unit coil is not limited to the winding body 21 and the segment coil 50 described above. For example, a hexagonal coil formed by helically winding a conductor wire into a hexagonal shape or a wave-like coil obtained by forming a conductor wire into a wave-like shape may be used. Specifically, the unit coil is only required to include 2n slot insertion portions and (2n−1) turn portions configured to continuously couple the 2n slot insertion portions, in which n is an integer equal to or larger than 1. The unit coil having n equal to 3 corresponds to the winding body 21, and the unit coil having n equal to 1 corresponds to the segment coil 50. In this manner, when the unit coils are mounted to the stator core, two terminal wires of each of the unit coils extend in the same axial direction of the stator core.

In each of the embodiments described above, there has been described a case in which six slot insertion portions are arranged in one row inside the slot. However, the number of slot insertion portions arranged in one row inside the slot is only required to be four or larger.

### REFERENCE SIGNS LIST

10 stator, 10A stator assembly, 11 stator core, 13 slot, 19 conductor wire, 20 stator winding, 20A stator winding assembly, 21 winding body (unit coil), 21A first winding body (unit coil), 21B second winding body (unit coil), 31, 31a, 31b insulation-coating removed portion, 32 insulation coating, 34 ridge lines, 50 segment coil (unit coil), 51a, 51b, 51c, 51d, 51e, 51f terminal wire, 52 bent portion, 60 holding tool, 61 bending tool, 62 chuck, 64 insulating member, 65 bending tool, S1 first slot insertion portion, S2 second slot insertion portion, S3 third slot insertion portion, S4 fourth slot insertion portion, S5 fifth slot insertion portion, S6 sixth slot insertion portion, T1A, T1B first turn portion (terminal wire), T12 second turn portion, T23 third turn portion, T34 fourth turn portion, T45 fifth turn portion, T56 sixth turn portion, T6A, T6B seventh turn portion (terminal wire), T1Ab oblique-side portion, T1Ac straight portion, T1Ad bent portion, T1Bb oblique-side portion, T1Bc straight portion, T1Bd bent portion, T6Ac straight portion, T6Bc straight portion, T6Bd bent portion

1. A stator, comprising:
a stator core having an annular shape, which has slots arranged at constant pitches in a circumferential direction of the stator core; and
a stator winding, which is mounted to the stator core, and includes a plurality of unit coils each being formed of a conductor wire covered with an insulation coating,
wherein each of the plurality of unit coils includes 2n slot insertion portions to be inserted into the slots, (2n−1) turn portions configured to continuously couple the 2n slot insertion portions outside the slots, and two terminal wires projecting from the slot insertion portions of the 2n slot insertion portions, which are located at both ends, to an outside of the slots, where n is an integer equal to or larger than 1,
wherein each of the two terminal wires has an oblique-side portion, which extends in the circumferential direction of the stator core, and gradually separates away from the stator core in a direction toward a distal end while maintaining a position in a radial direction of the stator core, and a straight portion extending outward from the distal end of the oblique-side portion in an axial direction of the stator core,
wherein the plurality of unit coils are electrically connected by welding a distal end portion of the straight portion of the terminal wire of one of the unit coils and a distal end portion of the straight portion of the terminal wire of another one of the unit coils being a subject of connection,
wherein the oblique-side portions of a pair of the terminal wires to be welded to each other extend so as to approach each other and are located at different positions in the radial direction of the stator core, and
wherein the straight portions of the pair of the terminal wires to be welded to each other are parallel to each other when viewed in the radial direction, and one of the straight portions is inclined in a direction toward another one of the straight portions through a boundary portion between the one straight portion and the oblique-side portion corresponding to the one straight portion as a bent portion in the radial direction so that the distal end portion of the one straight portion and the distal end portion of the another one of the straight portions intersect with each other when viewed in the circumferential direction of the stator core.

2. The stator according to claim 1, wherein a portion of the insulation coating of the one straight portion, which is located on a distal end side with respect to the bent portion, is removed.

3. The stator according to claim 2,
wherein the one straight portion has a rectangular cross section, and the one straight portion has a pair of flat surfaces on sides opposite to each other, which are oriented in the radial direction of the stator core, and has another pair of flat surfaces on the sides opposite to each other, which are oriented in the circumferential direction of the stator core,
wherein removal of the insulation coating on the pair of flat surfaces oriented in the radial direction is started at a position on the distal end side with respect to a position of start of removal of the insulation coating on the another pair of flat surfaces oriented in the circumferential direction, and
wherein surfaces of the straight portions of the pair of terminal wires to be welded to each other, which are oriented in the circumferential direction, are held in contact with each other.

4. The stator according to claim 1,
wherein the pairs of terminal wires, the terminal wires of each of the pairs being to be welded to each other, are located only on a radially inner end side and a radially outer end side of the slots in the radial direction of the stator core,
wherein, in the pair of terminal wires located on the radially inner end side of the slots, the another one of the straight portions extends from a boundary portion between the oblique-side portion corresponding to the another one of the straight portions and the another one of the straight portions in parallel to an axial direction of the stator core, and the distal end portion of the one straight portion is shifted radially inward by a thickness of the conductor wire in the radial direction of the stator core with respect to the boundary portion between the oblique-side portion corresponding to the one straight portion and the one straight portion, and
wherein, in the pair of terminal wires located on the radially outer end side of the slots, the another one of the straight portions extends from the boundary portion between the oblique-side portion corresponding to the another one of the straight portions and the another one of the straight portions in parallel to the axial direction of the stator core, and the distal end portion of the one straight portion is shifted radially outward by the thickness of the conductor wire in the radial direction of the stator core with respect to the boundary portion between the oblique-side portion corresponding to the one straight portion and the one straight portion.

5. The stator according to claim 1,
wherein the pairs of terminal wires, the terminal wires of each of the pairs being to be welded to each other, are located only on a radially inner end side and a radially outer end side of the slots in the radial direction of the stator core,
wherein the distal end portion of the one straight portion is shifted in a direction toward the distal end portion of the another one of the straight portions by half of a thickness of the conductor wire in the radial direction of the stator core with respect to the boundary portion between the oblique-side portion corresponding to the one straight portion and the one straight portion,
wherein the another one of the straight portions is inclined in a direction toward the one straight portion through a boundary portion between the oblique-side portion and the another one of the straight portions as a bent portion in the radial direction, and
wherein the distal end portion of the another one of the straight portions is shifted in the direction toward the one straight portion by half of the thickness of the conductor wire in the radial direction of the stator core with respect to the boundary portion between the oblique-side portion corresponding to the another one of the straight portions and the another one of the straight portions.

6. The stator according to claim 4, further comprising insulating members, which are inserted between the pair of terminal wires on the radially inner end side of the slots and the turn portion located on a radially outer side of the pair of terminal wires, and between the pair of terminal wires on the radially outer end side of the slots and the turn portion located on a radially inner side of the pair of terminal wires, respectively.

7. The stator according to claim 1,
wherein the pairs of terminal wires, the terminal wires of each of the pairs being to be welded to each other, are located on a radially inner end side and a radially outer end side of the slots, and in an intermediate region between the radially inner end side and the radially outer end side in the radial direction of the stator core,
wherein, in the pair of terminal wires located on the radially inner end side of the slots, the another one of the straight portions extends from a boundary portion between the oblique-side portion corresponding to the another one of the straight portions and the another one of the straight portions in parallel to an axial direction of the stator core, and the distal end portion of the one straight portion is shifted radially inward by a thickness of the conductor wire in the radial direction of the stator core with respect to the boundary portion between the oblique-side portion corresponding to the one straight portion and the one straight portion,
wherein, in the pair of terminal wires located on the radially outer end side of the slots, the another one of the straight portions extends from a boundary portion between the oblique-side portion corresponding to the another one of the straight portions and the another one of the straight portions in parallel to the axial direction of the stator core, and the distal end portion of the one straight portion is shifted radially outward by the thickness of the conductor wire in the radial direction of the stator core with respect to the boundary portion between the oblique-side portion corresponding to the one straight portion and the one straight portion, and
wherein, in the pair of terminal wires located in the intermediate region of the slots, the distal end portion of the one straight portion is shifted in a direction toward the distal end portion of the another one of the straight portions by half of the thickness of the conductor wire in the radial direction of the stator core with respect to the boundary portion between the oblique-side portion corresponding to the one straight portion and the one straight portion, the another one of the straight portions is inclined in a direction toward the one straight portion through the boundary portion between the oblique-side portion corresponding to the another one of the straight portions and the another one of the straight portions as the bent portion in the radial direction, and the distal end portion of the another one of the straight portions is shifted in the direction toward the one straight portion by half of the thickness of the conductor wire in the radial direction of the stator core with respect to the boundary portion between the oblique-side portion corresponding to the another one of the straight portion and the another one of the straight portion.

8. A stator assembly, comprising:
a stator core having an annular shape, which has slots arranged at constant pitches in a circumferential direction of the stator core; and
a stator winding assembly, which is mounted to the stator core, and includes a plurality of unit coils each being formed of a conductor wire covered with an insulation coating,
wherein each of the plurality of unit coils includes 2n slot insertion portions to be inserted into the slots, (2n−1) turn portions configured to continuously couple the 2n slot insertion portions outside the slots, and two terminals projecting from the slot insertion portions of the 2n slot insertion portions, which are located at both ends, to an outside of the slots, in which n is an integer equal to or larger than 1,
wherein each of the two terminal wires has an oblique-side portion, which extends in the circumferential direction of the stator core, and gradually separates away from the stator core in a direction toward a distal end while maintaining a position in a radial direction of the stator core and a straight portion extending outward from the distal end of the oblique-side portion in an axial direction of the stator core,
wherein each pair of the terminal wires being subjects of connection includes the terminal wire of one of the unit coils and the terminal wire of another one of the unit coils being a subject of connection,
wherein the oblique-side portions of the pair of terminal wires being subjects of connection extend so as to approach each other and are located at different positions in the radial direction of the stator core,
wherein the straight portions of the pair of the terminal wires being subjects of connection are parallel to each other when viewed in the radial direction, and one of the straight portions is inclined in a direction toward another one of the straight portions through a boundary portion between the one straight portion and the oblique-side portion corresponding to the one straight portion as a bent portion in the radial direction so that the distal end portion of the one straight portion and the distal end portion of the another one of the straight portions intersect with each other when viewed in the circumferential direction of the stator core,
wherein a distal end surface of the one straight portion inclined through the boundary portion between the oblique-side portion corresponding to the one straight portion and the one straight portion as the bent portion in the radial direction has an inverted V shape having a ridge line oriented in the circumferential direction of the stator core, and
wherein the ridge line of the one straight portion is located so as to fall within a region in which the distal end portion of the one straight portion and the distal end portion of the another one of the straight portions overlap with each other when viewed in the circumferential direction of the stator core.

9. A stator assembly, comprising:
a stator core having an annular shape, which has slots arranged at constant pitches in a circumferential direction of the stator core; and
a stator winding assembly, which is mounted to the stator core, and includes a plurality of unit coils each being formed of a conductor wire covered with an insulation coating,
wherein each of the plurality of unit coils includes 2n slot insertion portions to be inserted into the slots, (2n−1) turn portions configured to continuously couple the 2n slot insertion portions outside the slots, and two terminal wires projecting from the slot insertion portions of the 2n slot insertion portions, which are located at both ends, to an outside of the slots, in which n is an integer equal to or larger than 1,
wherein each of the two terminal wires includes an oblique-side portion, which extends in the circumferential direction of the stator core, and gradually separates away from the stator core in a direction toward a distal end while maintaining a position in a radial direction of the stator core, and a straight portion extending outward from the distal end of the oblique-side portion in an axial direction of the stator core,
wherein each pair of the terminal wires beings subjects of connection includes the terminal wire of one of the unit coils and the terminal wire of another one of the unit coils being a subject of connection,
wherein the oblique-side portions of the pair of terminal wires being subjects of connection extend so as to approach each other and are located at different positions in the radial direction of the stator core,
wherein the straight portions of the pair of the terminal wires being subjects of connection are parallel to each other when viewed in the radial direction, and one of the straight portions is inclined in a direction toward another one of the straight portions through a boundary portion between the one straight portion and the oblique-side portion corresponding to the one straight portion as a bent portion in the radial direction so that the distal end portion of the one straight portion and the distal end portion of the another one of the straight portions intersect with each other when viewed in the circumferential direction of the stator core,
wherein a distal end surface of the one straight portion inclined through the boundary portion between the oblique-side portion corresponding to the one straight portion and the one straight portion as the bent portion in the radial direction has an inverted V shape having a ridge line extending in the circumferential direction of the stator core, and
wherein an intersecting portion between the distal end surface of the inverted V shape of the one straight portion and a side surface of the one straight portion on a side radially opposite to a bending direction at the bent portion is located so as to fall within a region in which the distal end portion of the one straight portion and the distal end portion of the another straight portion overlap with each other.

10. A method of manufacturing the stator of claim 1, comprising:
a unit coil manufacturing step of manufacturing the unit coils;
a unit coil mounting step of mounting the unit coils to the stator core;
a terminal wire distal end portion forming step of forming the distal ends of the terminal wires of each of the unit coils; and
a terminal joining step of joining the distal end portions of the terminal wires,
wherein, in the terminal joining step, the distal end portion of the one straight portion and the distal end portion of the another one of the straight portions, which overlap with each other in the circumferential direction of the stator core, are chucked in the circumferential direction of the stator core, and are welded to each other from an axially outer side of the stator core.

11. The method of manufacturing the stator according to claim 10, wherein, in the terminal wire distal end portion forming step, the oblique-side portion is held by a holding tool in the radial direction of the stator core, and the one straight portion is pressed by a bending tool in a direction opposite to a holding direction by the holding tool to incline the one straight portion.

12. The method of manufacturing the stator according to claim 10, wherein, in the terminal wire distal end portion forming step, the oblique-side portion is held by a holding tool in the radial direction of the stator core, and a bending tool having a wedge-like shape is pushed into a side of the one straight portion, which is opposite to the holding tool, from the axially outer side of the stator core to incline the one straight portion.

13. The method of manufacturing the stator according to claim 12, wherein the bending tool has a ring shape.
